(19) United States
(12) Patent Application Publication
(10) Pub. No.: US 2023/0309170 A1
(43) Pub. Date: Sep. 28, 2023

(54) NEW BEAM IDENTIFICATION FOR PHYSICAL DOWNLINK CONTROL CHANNEL (PDCCH) REPETITION

(71) Applicant: QUALCOMM INCORPORATED, San Diego, CA (US)

(72) Inventors: Yan Zhou, San Diego, CA (US); Fang Yuan, Beijing (CN); Tao Luo, San Diego, CA (US)

(21) Appl. No.: 18/018,634

(22) PCT Filed: Sep. 24, 2020
(86) PCT No.: PCT/CN2020/117420

§ 371 Date: Jan. 30, 2023

(51) Int. Cl. H04W 76/19; H04W 24/08; H04L 5/00

(52) U.S. Cl. CPC H04W 76/19; H04W 24/08; H04L 5/0053

(57) ABSTRACT

This disclosure provides systems, methods and apparatus, including computer programs encoded on computer storage media, for beam identification for physical downlink control channel (PDCCH) repetition. Upon beam failure detection, a user equipment (UE) may identify candidate beams for re-establishing communications. The UE can use a set of channel state information reference signal (RS) resource configuration or synchronization signal/physical broadcast channel block indexes to determine a set of candidate beams. The set may include a list of a pair of RSs or indexes for serving cells that have radio link qualities below a threshold. The UE may report the candidate beams to a base station (BS) via a Media Access Control (MAC) Control Element (MAC-CE) or a physical random-access channel (PRACH) transmission. The BS may provide a configuration signal a resource set that includes a pair of RSs or indexes for serving cells with radio link qualities below the threshold.

### CROSS REFERENCE

The present Application is a 371 national stage filing of International PCT Application No. PCT/CN2020/117420 by Zhou et al. entitled “NEW BEAM IDENTIFICATION FOR PHYSICAL DOWNLINK CONTROL CHANNEL (PDCCH) REPETITION,” filed Sep. 24, 2020, which is assigned to the assignee hereof, and which is expressly incorporated by reference in its entirety herein.

### TECHNICAL FIELD

The following relates to wireless communications, including new beam identification for physical downlink control channel (PDCCH) repetition.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support new beam identification for physical downlink control channel (PDCCH) repetition.

One innovative aspect of the subject matter described in this disclosure can be implemented in a method of wireless communication at an apparatus of a user equipment (UE). The method may include receiving a configuration signal identifying a resource set that includes a pair of reference signals, monitoring for a physical downlink control channel (PDCCH) transmission using at least two transmission control indicator (TCI) states, detecting a beam failure according to the resource set and based on the monitoring, and determining a set of candidate beams based on detecting the beam failure.

Another innovative aspect of the subject matter described in this disclosure can be implemented in an apparatus for wireless communications at a UE. The apparatus may include a first interface and a processing system. The first interface may be configured to obtain a configuration signal identifying a resource set that includes a pair of reference signals. The processing system may be configured to monitor for a PDCCH transmission using at least two TCI states, detect a beam failure according to the resource set and based on the monitoring, and determine a set of candidate beams based on detecting the beam failure.

Another innovative aspect of the subject matter described in this disclosure can be implemented in an apparatus for wireless communications at a UE. The apparatus may include a processor, memory coupled with the processor, and instructions stored in the memory. The instructions may be executable by the processor to cause the apparatus to receive a configuration signal identifying a resource set that includes a pair of reference signals, monitor for a PDCCH transmission using at least two TCI states, detect a beam failure according to the resource set and based on the monitoring, and determine a set of candidate beams based on detecting the beam failure.

Another innovative aspect of the subject matter described in this disclosure can be implemented in another apparatus for wireless communications at a UE. The apparatus may include means for receiving a configuration signal identifying a resource set that includes a pair of reference signals, monitoring for a PDCCH transmission using at least two TCI states, detecting a beam failure according to the resource set and based on the monitoring, and determining a set of candidate beams based on detecting the beam failure.

Another innovative aspect of the subject matter described in this disclosure can be implemented in a non-transitory computer-readable medium storing code for wireless communications at an apparatus of a UE. The code may include instructions executable by a processor to receive a configuration signal identifying a resource set that includes a pair of reference signals, monitor for a PDCCH transmission using at least two TCI states, detect a beam failure according to the resource set and based on the monitoring, and determine a set of candidate beams based on detecting the beam failure.

In some implementations, the method, apparatuses, and non-transitory computer-readable medium described herein may further include operations, features, means, a second interface, or instructions for transmitting or outputting the set of candidate beams to a base station based on determining the set of candidate beams.

In some implementations of the method, apparatuses, and non-transitory computer-readable medium described herein, the pair of reference signals includes periodic channel state information reference signal (CSI-RS) resource configuration indexes, a set of synchronization signal block indexes, or a set of physical broadcast channel (PBCH) block indexes.

In some implementations of the method, apparatuses, and non-transitory computer-readable medium described herein, each of the pair of reference signals may be configured with either one or both of the at least two TCI states.

In some implementations of the method, apparatuses, and non-transitory computer-readable medium described herein, monitoring the PDCCH transmission further may include operations, features, means, or instructions for monitoring at least one control resource set (CORESET) associated with the at least two TCI states, monitoring one search space set associated with at least two CORESETs, or monitoring two search space sets associated with two CORESETs each having an active TCI state.

In some implementations of the method, apparatus, and non-transitory computer-readable medium described herein, the pair of reference signals is for determining the set of candidate beams upon detection of the beam failure.

Another innovative aspect of the subject matter described in this disclosure can be implemented in a method for wireless communications at an apparatus of a UE. The method may include receiving a configuration signal, detecting that a first radio link quality for a first serving cell is below a threshold radio link quality, providing an index for the first serving cell based on the configuration signal and detecting that the first radio link quality is below the threshold radio link quality, and inning response to detecting that the first radio link quality for the first serving cell is below the threshold radio link quality, transmitting information related to one or more candidate beams based on the received configuration signal.

Another innovative aspect of the subject matter described in this disclosure can be implemented in an apparatus for wireless communications at a UE. The apparatus may include a first interface, a processing system, and a second interface. The first interface may be configured to obtain a configuration signal. The processing system may be configured to detect that a first radio link quality for a first serving cell is below a threshold radio link quality and provide an index for the first serving cell based on the configuration signal and detecting that the first radio link quality is below the threshold radio link quality. The first interface or the second interface may be configured to in response to detecting that the first radio link quality for the first serving cell is below the threshold radio link quality, output information related to one or more candidate beams based on the received configuration signal.

Another innovative aspect of the subject matter described in this disclosure can be implemented in another apparatus for wireless communications at a UE. The apparatus may include a processor, memory coupled with the processor, and instructions stored in the memory. The instructions may be executable by the processor to cause the apparatus to receive a configuration signal, detect that a first radio link quality for a first serving cell is below a threshold radio link quality, provide an index for the first serving cell based on the configuration signal and detecting that the first radio link quality is below the threshold radio link quality, and in response to detecting that the first radio link quality for the first serving cell is below the threshold radio link quality, transmitting information related to one or more candidate beams based on the received configuration signal.

Another innovative aspect of the subject matter described in this disclosure can be implemented in another apparatus for wireless communications at a UE. The apparatus may include means for receiving a configuration signal, detecting that a first radio link quality for a first serving cell is below a threshold radio link quality, providing an index for the first serving cell based on the configuration signal and detecting that the first radio link quality is below the threshold radio link quality, and inning response to detecting that the first radio link quality for the first serving cell is below the threshold radio link quality, transmitting information related to one or more candidate beams based on the received configuration signal.

Another innovative aspect of the subject matter described in this disclosure can be implemented in a non-transitory computer-readable medium storing code for wireless communications at an apparatus of a UE. The code may include instructions executable by a processor to receive a configuration signal, detect that a first radio link quality for a first serving cell is below a threshold radio link quality, provide an index for the first serving cell based on the configuration signal and detecting that the first radio link quality is below the threshold radio link quality, and in response to detecting that the first radio link quality for the first serving cell is below the threshold radio link quality, transmitting information related to one or more candidate beams based on the received configuration signal.

In some implementations of the method, apparatuses, and non-transitory computer-readable medium described herein, receiving or obtaining the configuration signal further may include operations, features, means, or instructions for receiving or obtaining the configuration signal using a type of multiplexing, and transmitting or outputting the information related to the one or more candidate beams further may include operations, features, means, or instructions for transmitting or outputting the information using the type of multiplexing.

In some implementations of the method, apparatuses, and non-transitory computer-readable medium described herein, receiving the configuration signal further may include operations, features, means, or instructions for receiving the configuration signal using time division multiplexing (TDM), and transmitting or outputting the information related to the one or more candidate beams further may include operations, features, means, or instructions for transmitting the information using TDM.

In some implementations of the method, apparatuses, and non-transitory computer-readable medium described herein, receiving or obtaining the configuration signal further may include operations, features, means, or instructions for receiving or obtaining the configuration signal using frequency division multiplexing (FDM), and transmitting or outputting the information related to the one or more candidate beams further may include operations, features, means, or instructions for transmitting or outputting the information using FDM.

Another innovative aspect of the subject matter described in this disclosure can be implemented in a method for wireless communications at an apparatus of a UE. The method may include monitoring a PDCCH transmission using at least two TCI states, detecting a beam failure according to a resource set and based on the monitoring, determining a set of candidate beams based on detecting the beam failure, and transmitting an indication of the set of candidate beams in a media access control (MAC) control element (MAC-CE) or a physical random-access channel (PRACH) transmission.

Another innovative aspect of the subject matter described in this disclosure can be implemented in an apparatus for wireless communications at a UE. The apparatus may include a first interface and a processing system. The processing system may be configured to monitor a PDCCH transmission using at least two TCI states, detect a beam failure according to a resource set and based on the monitoring, and determine a set of candidate beams based on detecting the beam failure. The first interface may be configured to output an indication of the set of candidate beams in a MAC-CE or a PRACH transmission.

Another innovative aspect of the subject matter described in this disclosure can be implemented in another apparatus for wireless communications at a UE. The apparatus may include a processor, memory coupled with the processor, and instructions stored in the memory. The instructions may be executable by the processor to cause the apparatus to monitor a PDCCH transmission using at least two TCI states, detect a beam failure according to a resource set and based on the monitoring, determine a set of candidate beams based on detecting the beam failure, and transmit an indication of the set of candidate beams in a MAC-CE or a PRACH transmission.

Another innovative aspect of the subject matter described in this disclosure can be implemented in another apparatus for wireless communications at a UE. The apparatus may include means for monitoring a PDCCH transmission using at least two TCI states, detecting a beam failure according to a resource set and based on the monitoring, determining a set of candidate beams based on detecting the beam failure, and transmitting an indication of the set of candidate beams in a MAC-CE or a PRACH transmission.

Another innovative aspect of the subject matter described in this disclosure can be implemented in a non-transitory computer-readable medium storing code for wireless communications at an apparatus of a UE. The code may include instructions executable by a processor to monitor a PDCCH transmission using at least two TCI states, detect a beam failure according to a resource set and based on the monitoring, determine a set of candidate beams based on detecting the beam failure, and transmit an indication of the set of candidate beams in a MAC-CE or a PRACH transmission.

In some implementations, the method, apparatuses, and non-transitory computer-readable medium described herein may further include operations, features, means, or instructions for setting a bit of the MAC-CE to indicate whether there may be one or two reference signal identifications in the MAC-CE.

In some implementations, the method, apparatuses, and non-transitory computer-readable medium described herein may further include operations, features, means, or instructions for setting a field of the MAC-CE to indicate that the beam failure may be detected.

In some implementations, the method, apparatuses, and non-transitory computer-readable medium described herein may further include operations, features, means, or instructions for setting a field of the MAC-CE to indicate a presence of a candidate reference signal identification.

In some implementations of the method, apparatuses, and non-transitory computer-readable medium described herein, the indication of the set of candidate beams further indicates at least one candidate reference signal pair identification.

In some implementations of the method, apparatuses, and non-transitory computer-readable medium described herein, the PRACH transmission may be associated with a pair of at least one synchronization signal block (SSB) or CSI-RS.

In some implementations, the method, apparatuses, and non-transitory computer-readable medium described herein may further include operations, features, means, or instructions for monitoring a first CORESET for the PDCCH transmission based on the at least two TCI states or a quasi co-location assumption associated with the PRACH transmission.

In some implementations, the method, apparatuses, and non-transitory computer-readable medium described herein may further include operations, features, means, or instructions for monitoring at least one search space set associated with at least one CORESET for the PDCCH transmission based on the indication of the set of candidate beams.

In some implementations, the method, apparatuses, and non-transitory computer-readable medium described herein may further include operations, features, means, or instructions for receiving a second indication of the at least one search space set.

In some implementations of the method, apparatuses, and non-transitory computer-readable medium described herein, the at least one search space set may be based on at least one of the at least two TCI states or a quasi co-location assumption associated with the PRACH transmission.

Another innovative aspect of the subject matter described in this disclosure can be implemented in a method for wireless communications at an apparatus of a base station. The method may include transmitting a configuration signal to a UE identifying a resource set that includes a pair of reference signals and receiving a set of candidate beams from the UE based on determining the set of candidate beams upon detection of a beam failure at the UE.

Another innovative aspect of the subject matter described in this disclosure can be implemented in an apparatus for wireless communications at a base station. The apparatus may include a first interface and a second interface. The first interface may be configured to output a configuration signal for transmission to a UE identifying a resource set that includes a pair of reference signals. The first or second interface may be configured to obtain a set of candidate beams from the UE based at least in part on determining the set of candidate beams upon detection of a beam failure at the UE.

Another innovative aspect of the subject matter described in this disclosure can be implemented in another apparatus for wireless communications at a base station. The apparatus may include a processor, memory coupled with the processor, and instructions stored in the memory. The instructions may be executable by the processor to cause the apparatus to transmit a configuration signal to a UE identifying a resource set that includes a pair of reference signals and receive a set of candidate beams from the UE based on determining the set of candidate beams upon detection of a beam failure at the UE.

Another innovative aspect of the subject matter described in this disclosure can be implemented in another apparatus for wireless communications at a base station. The apparatus may include means for transmitting a configuration signal to a UE identifying a resource set that includes a pair of reference signals and receiving a set of candidate beams from the UE based on determining the set of candidate beams upon detection of a beam failure at the UE.

Another innovative aspect of the subject matter described in this disclosure can be implemented in a non-transitory computer-readable medium storing code for wireless communications at an apparatus of a base station. The code may include instructions executable by a processor to transmit a configuration signal to a UE identifying a resource set that includes a pair of reference signals and receive a set of candidate beams from the UE based on determining the set of candidate beams upon detection of a beam failure at the UE.

In some implementations, the method, apparatuses, and non-transitory computer-readable medium described herein may further include operations, features, means, or instructions for re-establishing a connection with the UE using the set of candidate beams.

In some implementations of the method, apparatuses, and non-transitory computer-readable medium described herein, the pair of reference signals includes periodic CSI-RS resource configuration indexes, a set of synchronization signal block indexes, or a set of PBCH block indexes.

In some implementations of the method, apparatuses, and non-transitory computer-readable medium described herein, each of the pair of reference signals may be configured with either one or both of at least two TCI states.

In some implementations of the method, apparatus, and non-transitory computer-readable medium described herein, the pair of reference signals is for determining the set of candidate beams upon detection of the beam failure.

Another innovative aspect of the subject matter described in this disclosure can be implemented in a method for wireless communications at an apparatus of a base station. The method may include transmitting a configuration signal that instructs a UE to provide an index for a corresponding serving cell with a radio link quality below a threshold radio link quality and receiving information related to one or more candidate beams corresponding to a first serving cell based on the configuration signal, where a first radio link quality for the first serving cell is below the threshold radio link quality.

Another innovative aspect of the subject matter described in this disclosure can be implemented in an apparatus for wireless communications at a base station. The apparatus may include a first interface and a processing system. The first interface may be configured to output a configuration signal for transmission that instructs a UE to provide an index for a corresponding serving cell with a radio link quality below a threshold radio link quality. The first interface or the second interface may be configured to obtain information related to one or more candidate beams corresponding to a first serving cell based at least in part on the configuration signal, where a first radio link quality for the first serving cell is below the threshold radio link quality.

Another innovative aspect of the subject matter described in this disclosure can be implemented in another apparatus for wireless communications at a base station. The apparatus may include a processor, memory coupled with the processor, and instructions stored in the memory. The instructions may be executable by the processor to cause the apparatus to transmit a configuration signal that instructs a UE to provide an index for a corresponding serving cell with a radio link quality below a threshold radio link quality and receive information related to one or more candidate beams corresponding to a first serving cell based on the configuration signal, where a first radio link quality for the first serving cell is below the threshold radio link quality.

Another innovative aspect of the subject matter described in this disclosure can be implemented in another apparatus for wireless communications at a base station. The apparatus may include means for transmitting a configuration signal that instructs a UE to provide an index for a corresponding serving cell with a radio link quality below a threshold radio link quality and receiving information related to one or more candidate beams corresponding to a first serving cell based on the configuration signal, where a first radio link quality for the first serving cell is below the threshold radio link quality.

Another innovative aspect of the subject matter described in this disclosure can be implemented in a non-transitory computer-readable medium storing code for wireless communications at an apparatus of a base station. The code may include instructions executable by a processor to transmit a configuration signal that instructs a UE to provide an index for a corresponding serving cell with a radio link quality below a threshold radio link quality and receive information related to one or more candidate beams corresponding to a first serving cell based on the configuration signal, where a first radio link quality for the first serving cell is below the threshold radio link quality.

In some implementations of the method, apparatuses, and non-transitory computer-readable medium described herein, transmitting or outputting the configuration signal further may include operations, features, means, or instructions for transmitting or outputting the configuration signal using a type of multiplexing, and receiving or obtaining the information related to the one or more candidate beams further may include operations, features, means, or instructions for receiving or obtaining the information using the type of multiplexing.

In some implementations of the method, apparatuses, and non-transitory computer-readable medium described herein, transmitting or outputting the configuration signal further may include operations, features, means, or instructions for transmitting or outputting the configuration signal using TDM, and receiving or obtaining the information related to the one or more candidate beams further may include operations, features, means, or instructions for receiving or obtaining the information using TDM.

In some implementations of the method, apparatuses, and non-transitory computer-readable medium described herein, transmitting or outputting the configuration signal further may include operations, features, means, or instructions for transmitting or outputting the configuration signal using FDM, and receiving or obtaining the information related to the one or more candidate beams further may include operations, features, means, or instructions for receiving or obtaining the information using FDM.

Another innovative aspect of the subject matter described in this disclosure can be implemented in a method for wireless communications at an apparatus of a base station. The method may include receiving an indication of a set of candidate beams for connection reestablishment with a UE in a MAC-CE or a PRACH transmission and re-establishing a connection with the UE using the set of candidate beams.

Another innovative aspect of the subject matter described in this disclosure can be implemented in an apparatus for wireless communications at a base station. The apparatus may include a first interface and a processing system. The first interface may be configured to obtain an indication of a set of candidate beams for connection reestablishment with a UE in a MAC-CE or a PRACH transmission. The processing system may be configured to re-establish a connection with the UE using the set of candidate beams.

Another innovative aspect of the subject matter described in this disclosure can be implemented in another apparatus for wireless communications at a base station. The apparatus may include a processor, memory coupled with the processor, and instructions stored in the memory. The instructions may be executable by the processor to cause the apparatus to receive an indication of a set of candidate beams for connection re-establishment with a UE in a MAC-CE or a PRACH transmission and re-establish a connection with the UE using the set of candidate beams.

Another innovative aspect of the subject matter described in this disclosure can be implemented in another apparatus for wireless communications at a base station. The apparatus may include means for receiving an indication of a set of candidate beams for connection reestablishment with a UE in a MAC-CE or a PRACH transmission and re-establishing a connection with the UE using the set of candidate beams.

Another innovative aspect of the subject matter described in this disclosure can be implemented in a non-transitory computer-readable medium storing code for wireless communications at an apparatus of a base station. The code may include instructions executable by a processor to receive an indication of a set of candidate beams for connection reestablishment with a UE in a MAC-CE or a PRACH transmission and re-establish a connection with the UE using the set of candidate beams.

In some implementations, the method, apparatuses, and non-transitory computer-readable medium described herein may further include operations, features, means, or instructions for identifying a bit of the MAC-CE to determine whether there may be one or two reference signal identifications in the MAC-CE.

In some implementations, the method, apparatuses, and non-transitory computer-readable medium described herein may further include operations, features, means, or instructions for identifying a field of the MAC-CE to determine that the UE detected a beam failure.

In some implementations, the method, apparatuses, and non-transitory computer-readable medium described herein may further include operations, features, means, or instructions for identifying a field of the MAC-CE that indicates a presence of a candidate reference signal identification.

In some implementations of the method, apparatuses, and non-transitory computer-readable medium described herein, the indication of the set of candidate beams further indicates at least one candidate reference signal pair identification.

In some implementations of the method, apparatuses, and non-transitory computer-readable medium described herein, the PRACH transmission may be associated with a pair of at least one SSB or CSI reference signal.

In some implementations, the method, apparatuses, and non-transitory computer-readable medium described herein may further include operations, features, means, or instructions for transmitting or outputting an indication of at least one search space set associated with at least one CORESET for a PDCCH transmission.

In some implementations of the method, apparatuses, and non-transitory computer-readable medium described herein, the at least one search space set may be based on at least one of a TCI state or a quasi co-location assumption associated with the PRACH transmission.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1 and 2 show examples of wireless communications systems that support new beam identification for physical downlink control channel (PDCCH) repetition.

FIGS. 3 through 5 show examples of process flows that support new beam identification for PDCCH repetition.

FIGS. 6A and 6B show example diagrams of component carrier octets that support new beam identification for PDCCH repetition.

FIG. 7 shows a diagram of an example system including a device that supports new beam identification for PDCCH repetition.

FIG. 8 shows a diagram of an example system including a device that supports new beam identification for PDCCH repetition.

FIGS. 9 through 14 show flowcharts illustrating example methods that support new beam identification for PDCCH repetition.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In some wireless communications systems, a user equipment (UE) may support beamforming or use of multiple beams for communication with a base station (BS), a network entity, or another device. The UE may support beam indication which may imply that some physical downlink control channel (PDCCH) transmissions may use a same transmission beam as a configured reference signal (RS) (such as a channel state information reference signal (CSI-RS) or synchronization signal (SS) block (SSB)). Beam indication may be based on configuration and downlink signaling of transmission configuration indicator (TCI) states. TCI states may include, for example, information about a CSI-RS or an SSB and information related to quasi co-location (QCL) relationships. By associating a downlink transmission over PDCCH with a certain TCI, the base station may inform the UE that the UE can assume that the PDCCH transmission is transmitted using a same spatial filter as the reference signal associated with the TCI state. However, sometimes a beam failure can occur, and the beam may be re-established.

The UE may monitor the PDCCH for beam failure. The UE may detect that a beam failure has occurred when the error probability for the PDCCH exceeds a threshold value or based on a measurement of a reference signal transmitted over the PDCCH. For example, the UE may assume that a beam failure has occurred based on a measurement of a periodic CSI-RS associated with a PDCCH TCI state. However, in order to detect a beam failure based on measurements of a reference signal, the UE may be configured with one or more sets of indexes that can be used to detect beam failure.

A base station, such as a gNB, may configure the UE with configuration indexes that may be used for detecting beam failure and determining a candidate set of beams for beam recovery. For example, a base station may provide the UE, for each bandwidth part (BWP) of a serving cell, with a beam failure detection resource set q0 of periodic CSI-RS resource configuration indexes and a new candidate beam resource set q1 of periodic CSI-RS resource configuration indexes or synchronization signal/physical broadcast channel (PBCH) block indexes. The UE may use the set q0 to detect beam failures and use the set q1 to identify candidate beams for connection re-establishment after beam failure. Additionally, the UE may use the set q0 and the set q1 for performing radio link quality measurements on a BWP of a serving cell.

It may be straightforward for the UE to determine a new candidate beam resource set q1 and the candidate beam when PDCCH is monitored with a single TCI state. For example, in 3GPP NR Release 15, PDCCH is monitored in a CORESET, and a CORESET can be activated with a single active TCI state. However, in New Radio (NR), PDCCH may be configured to be monitored with two TCI states. PDCCH transmissions or PDCCH candidates to be monitored with two TCI states may use alternative numbers of control resource sets (CORESETs) and search space (SS) sets. For example, a PDCCH transmission or a PDCCH candidate may be monitored in a single CORESET which can be configured with two active TCI states. Alternatively, a PDCCH transmission or a PDCCH candidate may be monitored in one SS set which is associated with two different CORESETs, and each CORESET may be configured with an active TCI state. Another alternative is that a PDCCH transmission or a PDCCH candidate may be monitored in two SS sets, and the two SS sets can be associated with two CORESETs each of which is configured with an active TCI state. Techniques described herein enable the UE to determine two or more candidate beams from a new candidate beam resource set q1 when there are two TCI states for monitoring a PDCCH. In some examples, the techniques apply when the TCI states provide QCL Type D reference signals, which define spatial receive parameters. Techniques described herein provide for the UE to identify and output two or more candidate beams when one or both of these PDCCH beams fail.

When the UE detects that a beam failure has occurred, the UE may attempt to identify a new beam, or a new beam pair, in order to restore connectivity. The base station (BS) may provide or configure the UE with the new candidate beam resource set q1, which may include periodic CSI-RS resource configuration indexes or SS/PBCH block indexes using radio resource control (RRC) signaling, such as candidateBeamRSList, candidateBeamRSListExt-r16, candidateBeamRSSCellList-r16, or any other such suitable signaling, for radio link quality measurements on the BWP. When a beam failure is detected, the UE may find a new candidate beam in the new candidate beam resource set q1 and provide an indication of the new candidate beam to the gNB. That is, the UE may identify an appropriate candidate beam and indicate it to the gNB, which may be via a Media Access Control (MAC) control element (MAC-CE). The MAC-CE may provide the serving cell indexes and an indication of the beam failure event.

Upon detection of a beam failure, the UE may find two new candidate beams that may be applied for the same PDCCH transmission and may report them to the gNB. The UE may use the new candidate beam resource set q1 or related information to identify the new candidate beams to re-establish the connection after a beam failure. In some implementations, the new candidate beam resource set q1 is configured by the gNB to include a list of a pair of reference signals (RSs), where each pair of RSs include one or two RSs and each RS in the pair can be configured to be associated with a TCI state.

In some other implementations, the UE can provide the gNB with one or more indexes for at least corresponding serving cells that have a radio link quality worse than a threshold. The indexes can indicate the presence of the new beam information (such as the set q_{new} which contain one or two new candidate beams) for the corresponding serving cells, and the candidate beam index(es) in the set q_{new} for a periodic CSI-RS configuration or for a SS/PBCH block from the new candidate beam resource set q1. In some examples, the gNB may configure the UE to report two new candidate beams in the set q_{new}, and the two new candidate beams, when applied for monitoring the same PDCCH transmission, can ensure the hypothetical block error rate (BLER) of the PDCCH transmission is better than a configured threshold. When the UE is configured to report two new candidate beams in the set q_{new}, the gNB may send a configuration signal indicating a multiplexing scheme for the two new candidate beams. The multiplexing scheme for two new candidate beams in the set q_{new} can be a time division multiplexing (TDM), frequency division multiplexing (FDM) scheme, or spatial division multiplexing (SDM) scheme. The UE may apply the same multiplexing type to two new candidate beams in the set q_{new} as the multiplexing type used for the configuration signal, where the configuration signal is indicated for evaluating the hypothetical BLER of the PDCCH transmission that is used for identifying new beams during beam failure recovery. The UE also may report to the gNB about the UE's capability of multiplexing scheme (i.e., TDM, FDM or SDM).

In some implementations, the UE can provide the information related to the one or two new candidate beam RSs in the beam failure recovery MAC-CE. For example, if the UE is configured with eight component carriers (CCs) in carrier aggregation, different bits in an octet of a MAC-CE correspond to different CCs and can be used to indicate the one or more CCs detected with a beam failure event. The UE also can use the MAC-CE to indicate new candidate beam RSs for one or more CCs that have a beam failure event. For each CC detected during the beam failure event, the UE can indicate in the MAC-CE that none, one, or two new candidate beam RSs are re-reported as the new beam information for beam failure recovery. In some implementations, instead of reporting one or two new candidate beam RSs, the UE can provide information related to an RS pair identification to the gNB in the MAC-CE.

In some implementations, the UE reports the new beam information via an enhanced physical random-access channel (PRACH) association. Each PRACH transmission occasion can be associated with a new beam information in the new candidate beam resource set q1, and the new beam information can be a pair of one or two RSs such as SSBs or CSI-RSs. The UE may indicate the new beam information, or the set q_{new}, to the gNB by selecting a corresponding associated PRACH transmission occasion. After the PRACH transmission that indicates the new beam information q_{new}, the UE may monitor a response from the gNB. The gNB may transmit a response in a PDCCH. The UE may use the new beam information q_{new} indicated in the PRACH to monitor for a response from the gNB. In some implementations, the UE may monitor for the response in preconfigured PDCCH monitoring occasions.

When the new beam information q_{new} contains two new candidate beams (such as RSs or TCI states), the UE may use two new candidate beams in the set q_{new} associated with the PRACH to monitor the preconfigured PDCCH monitoring occasions for the response. For example, preconfigured PDCCH monitoring occasions may be in a CORESET, and the UE may monitor the CORESET using the two new candidate beams in the set q_{new} associated with the PRACH. Alternatively, the UE may be configured with a recovery search space identification that provides one search space set, which is associated with two different CORESETs, and the UE may monitor the preconfigured PDCCH monitoring occasions in the two CORESETs using the two new candidate beams in the set q_{new} associated with the PRACH. In some other implementations, the UE can provide a recovery search space identification that provides one search space set, which is associated with one or two different CORESETs. The UE may report one or two new candidate beam in the set q_{new} to the gNB, and the UE may monitor the preconfigured PDCCH monitoring occasions for the response on the search space sets associated with one of the CORESETs when one new candidate beam is reported in the set q_{new}, or both CORESETs when two new candidate beams are reported in the set q_{new}.

Particular implementations of the subject matter described in this disclosure can be implemented to realize one or more of the following potential advantages. For example, the described techniques may lead to improved efficiency and communications, as well as improving configurations for communications using multiple TCI states. The described techniques also may improve beam failure recovery. This may lead to faster and more robust connection re-establishment, which may improve user experience. Reporting multiple new candidate beams during the beam failure recovery may increase the successful rate of beam failure recovery. The described techniques also may improve power savings, leading to increased battery life.

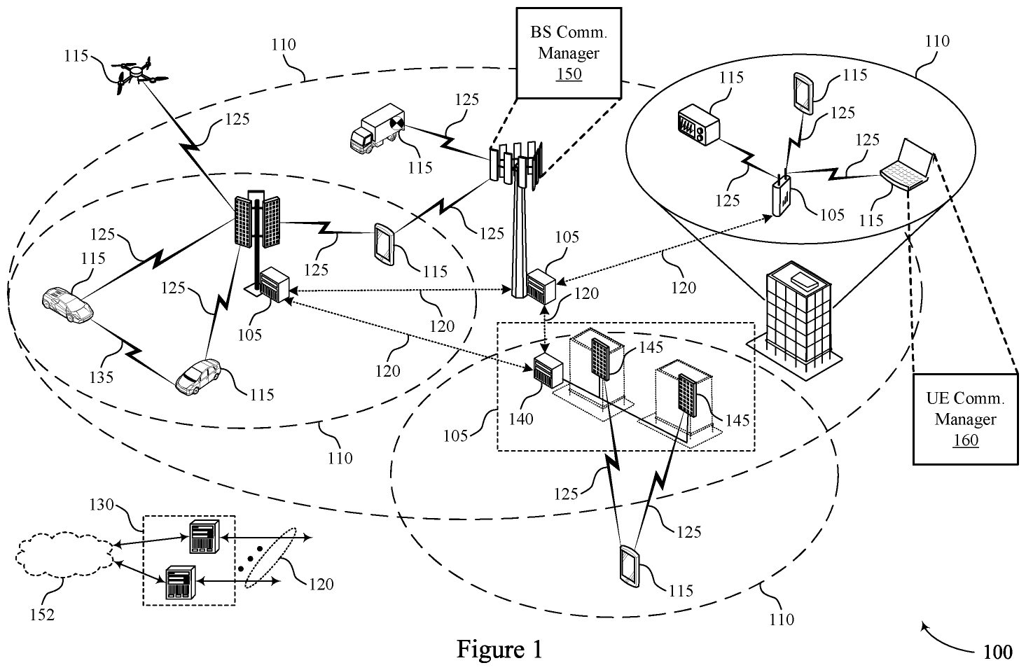

FIG. 1 illustrates an example of a wireless communications system 100 that supports new beam identification for PDCCH repetition in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (such as mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The geographic coverage area 110 may be an example of a geographic area over which a base station 105 and a UE 115 may support the communication of signals according to one or more radio access technologies.

The UEs 115 may be dispersed throughout a geographic coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (such as core network nodes, relay devices, integrated access and backhaul (IAB) nodes, or another network equipment), as shown in FIG. 1.

The base stations 105 may communicate with the core network 130, or with one another, or both. For example, the base stations 105 may interface with the core network 130 through one or more backhaul links 120 (such as via an S1, N2, N3, or another interface). The base stations 105 may communicate with one another over the backhaul links 120 (such as via an X2, Xn, or other interface) either directly (such as directly between base stations 105), or indirectly (such as via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (such as a BWP) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (such as in a carrier aggregation configuration), a carrier also may have acquisition signaling or control signaling that coordinates operations for other carriers. A carrier may be associated with a frequency channel (such as an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (such as of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (such as in an FDD mode) or may be configured to carry downlink and uplink communications (such as in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (such as 1.4, 3, 5, 10, 15, 20, 40, or 80 megahertz (MHz)). Devices of the wireless communications system 100 (such as the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (such as a sub-band, a BWP) or all of a carrier bandwidth.

Signal waveforms transmitted over a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (such as a duration of one modulation symbol) and one subcarrier, where the symbol period and subcarrier spacing are inversely related. The number of bits carried by each resource element may depend on the modulation scheme (such as the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (such as spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some examples, a frame may be divided (such as in the time domain) into subframes, and each subframe may be further divided into a number of slots. Alternatively, each frame may include a variable number of slots, and the number of slots may depend on subcarrier spacing. Each slot may include a number of symbol periods (such as depending on the length of the cyclic prefix prepended to each symbol period). In some wireless communications systems 100, a slot may further be divided into multiple mini-slots containing one or more symbols. Excluding the cyclic prefix, each symbol period may contain one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some examples, the TTI duration (such as the number of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (such as a CORESET) for a physical control channel may be defined by a number of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In some other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (such as mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 also may be able to communicate directly with other UEs 115 over a device-to-device (D2D) communication link 135 (such as using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other implementations, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 152 for one or more network operators. The IP services 152 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (such as radio heads and ANCs) or consolidated into a single network device (such as a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (such as less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (such as LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which also may be referred to as spatial filtering, directional transmission, or directional reception, is a signal processing technique that may be used at a transmitting device or a receiving device (such as a base station 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (such as antenna panels) to conduct beamforming operations for directional communications with a UE 115. Some signals (such as synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (such as by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (such as a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (such as by a base station 105 or a UE 115) may be performed using multiple beam directions, and the device may use a combination of digital precoding or radio frequency beamforming to generate a combined beam for transmission (such as from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (such as for identifying a beam direction for subsequent transmission or reception by the UE 115) or for transmitting a signal in a single direction (such as for transmitting data to a receiving device).

A receiving device (such as a UE 115) may try multiple receive configurations (such as directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (such as when receiving a data signal). The single receive configuration may be aligned in a beam direction determined based on listening according to different receive configuration directions (such as a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer also may use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A base station 105 may include a base station communications manager 150. In some implantations, the base station communications manager 150 may transmit a configuration signal to a UE 115 identifying a resource set that includes a pair of reference signals for determining a set of candidate beams upon detection of a beam failure and receive the set of candidate beams from the UE 115 based on determining the set of candidate beams upon detection of the beam failure at the UE 115.

In some other implementations, the base station communications manager 150 also may transmit a configuration signal that instructs the UE 115 to provide an index for a corresponding serving cell with a radio link quality below a threshold radio link quality and receive information related to one or more candidate beams corresponding to a first serving cell based on the configuration signal, where a first radio link quality for the first serving cell is below the threshold radio link quality.

In some other implementations, the base station communications manager 150 may transmit a configuration signal to the UE 115 identifying a resource set that includes a pair of reference signals for determining a set of candidate beams upon detection of a beam failure and receive the set of candidate beams from the UE 115 based on determining the set of candidate beams upon detection of the beam failure at the UE 115.

A UE 115 may include a UE communications manager 160. In some implementations, the UE communications manager 160 may receive a configuration signal identifying a resource set that includes a pair of reference signals, monitor for a PDCCH transmission using at least two TCI states, detect a beam failure for the PDCCH monitoring according to the resource set and based on the monitoring, and determine a set of candidate beams based on detecting the beam failure.

In some other implementations, the UE communications manager 160 may receive a configuration signal, detect that a first radio link quality for a first serving cell is below a threshold radio link quality and provide an index for the first serving cell based on the configuration signal and detecting that the first radio link quality is below the threshold radio link quality. In response to detecting that the first radio link quality for the first serving cell is below the threshold radio link quality, the UE communications manager 710 may transmit information related to one or more candidate beams based on the received configuration signal.

In some other implementations, the UE communications manager 160 may monitor a PDCCH transmission using at least two TCI states, detect a beam failure for the PDCCH monitoring according to a resource set and based on the monitoring, determine a set of candidate beams based on detecting the beam failure, and transmit an indication of the set of candidate beams in a MAC-CE or a PRACH transmission.

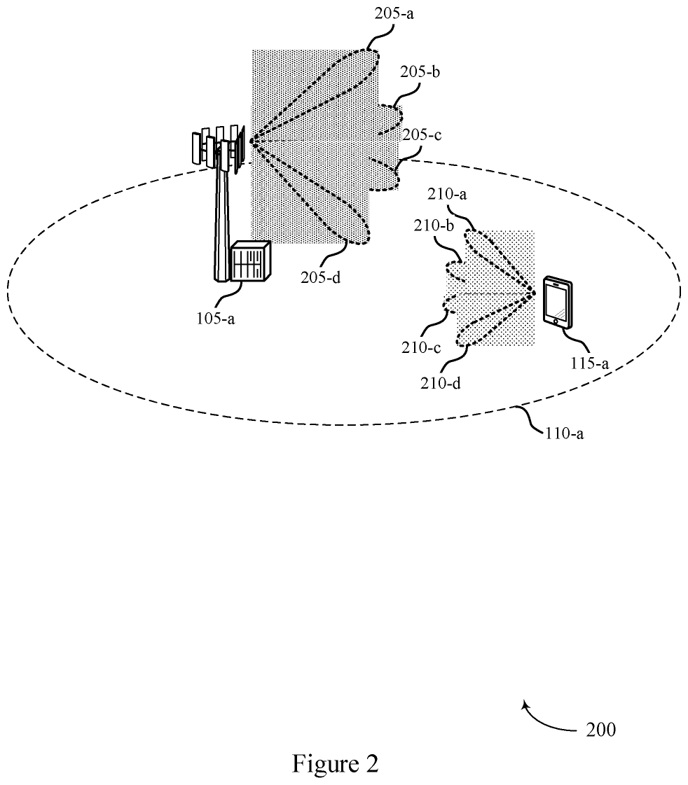

FIG. 2 shows an example of a wireless communications system 200 that supports new beam identification for PDCCH repetition. In some examples, wireless communications system 200 may implement aspects of wireless communications system 100. The wireless communications system 200 includes base station 105-a and a UE 115-a, which may be examples of the corresponding devices described with reference to FIG. 1.

The base station 105-a may support communications with wireless devices inside a geographic coverage area 110-a. The base station 105-a may transmit signals over one or more beams 205-a through 205-d (referred to collectively herein as beams 205). In some other examples, the base station 105-a may use more or less than the four beams 205 shown in FIG. 2. For example, the base station 105-a may make PDCCH transmissions over beams 205-c and 205-d to the UE 115-a. In some other examples, the base station 105-a may make PDCCH transmissions using different arrangements and numbers of beams 205. The UE 115-a may likewise transmit beams 210-a through 210-d (referred to collectively herein as beams 210).

The base station 105-a and the UE 115-a may support beam indication which may imply that some PDCCH transmissions may use a same transmission beam as a configured reference signal (such as a CSI-RS or an SSB). Beam indication may be based on configuration and downlink signaling of TCI states. TCI states may include information about a CSI-RS or SSB and QCL. By associating a downlink transmission over PDCCH with a certain TCI state, the base station 105-a may inform the UE 115-a that it can assume that the PDCCH transmission is transmitted using a same spatial filter as the reference signal associated with the TCI state.

The PDCCH may be configured to be monitored with two TCI states. PDCCH transmissions having two TCI states may use alternative numbers of CORESETs and search space sets. In some implementations, the base station 105-b may transmit PDCCH transmissions using one or more beams 205 associated with multiple TCI states according to one of the alternatives. The UE 115-a may receive the PDCCH transmissions over two or more beams 205 by monitoring resource sets associated with the two or more TCI states. For example, the UE 115-a may monitor for the PDCCH transmission using at least two TCI states.

However, there may be situations in which at least one of the beams 205 fails. Beam failure may occur due to an obstruction in the pathway, power loss, interference, a change in channel conditions, multipath effects, or the like. The UE 115-a may determine candidate beams for re-establishing the connection when a beam failure has occurred. Techniques described herein enable the UE 115-a to determine and report one or more candidate beams to the base station 105-b upon detection of a beam failure.

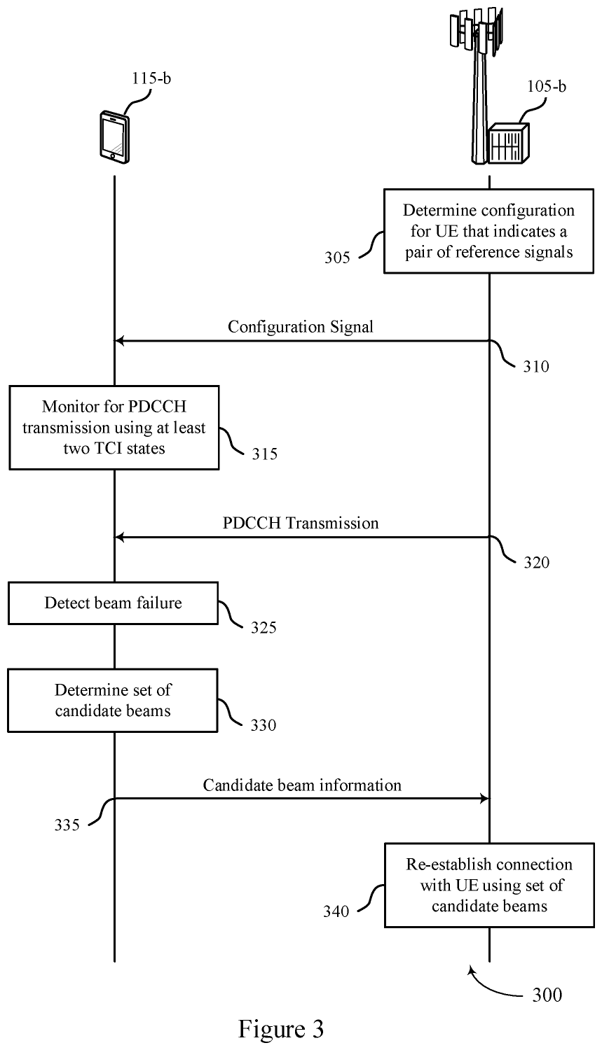

FIG. 3 shows an example of a process flow 300 that supports new beam identification for PDCCH repetition. In some examples, the process flow 300 may implement aspects of wireless communications systems 100 and 200. The process flow 300 may include a base station 105-b and a UE 115-b, which may be examples of the corresponding devices described with reference to FIGS. 1 and 2.

At 305, the base station 105-b may determine configuration information for the UE. The configuration information may identify a resource set, such as the set q1, that includes a pair of reference signals for determining the new candidate beam information upon detection of a beam failure. In some examples, the configuration information includes a list of a pair of RSs in the set q1 and each pair of RSs can have one or two RSs. Each RS in the set q1 may be configured or associated with a TCI state (i.e., provided that the RS is a QCL type D RS). The base station 105-b may transmit a corresponding configuration signal 310 to the UE 115-b. In some examples, the configuration signal includes a set q1. In some examples, the configuration information 310 may include a downlink control information (DCI) message or an RRC message. In some examples, the configuration signal 310 also may indicate to the UE 115-b that a PDCCH transmission may be enabled to be monitored with two TCI states. The base station 105-a may send PDCCH transmissions using at least one CORESET associated with the at least two TCI states, one search space set associated with at least two CORESETs, or two search space sets associated with two CORESETs each having an active TCI state.

In some examples, a UE can be provided, for each BWP of a serving cell, a set q0 of periodic CSI-RS resource configuration indexes by failureDetectionResources and a set q1 of periodic CSI-RS resource configuration indexes and/or SS/PBCH block indexes by candidateBeamRSList or candidateBeamRSListExt-r16 or candidateBeamRSSCellList-r16, or any other for radio link quality measurements on the BWP of the serving cell. The UE can transmit in a MAC-CE providing index(es) for at least corresponding serving cell(s) with radio link quality worse than Q_{out,LR}, indication(s) of presence of the new beam information q_{new}, for corresponding serving cell(s), and RS index(es) in the q_{new} for a periodic CSI-RS configuration or for a SS/PBCH block provided by higher layers, if any, for corresponding serving cell(s).

At 315, the UE 115-b may monitor for PDCCH transmissions using the TCI states. The UE 115-b may monitor for PDCCH transmissions using at least one CORESET associated with the at least two TCI states, one search space set associated with at least two CORESETs, or two search space sets associated with two CORESETs each having an active TCI state. The base station 105-b may output one or more PDCCH transmissions 320.

At 325, the UE 115-b may detect a beam failure of one or both of the beams. Based on detecting the beam failure, the UE 115-b may determine a set of new candidate beams for beam failure recovery at 330. The UE 115-b may determine the set of new candidate beams based on the pair of reference signals in the list indicated in the configuration signal 310. The UE 115-b may use the list of the pair of RSs, where each pair of RSs is configured with either one or two RSs, to determine a set of potential new candidate beams for re-establishment of the connection with the base station 105-b. For example, the UE can evaluate the hypothetical BLER for a PDCCH transmission by jointly considering a pair of two beams in the list indicated in the configuration signal 310 during beam failure recovery, and the UE may report the pair of two beams as the new beam information q_{new} if the evaluated hypothetical BLER is better than a threshold.

The UE 115-b may output a candidate beam information 335 that informs the base station 105-b of the identity of a set of potential beams for re-establishing the connection. At 340, the base station 105-b may re-establish the connection with the UE 115-b using one or more candidate beams indicated in the candidate beam information 335. The base station 105-b may use various metrics to select the one or more candidate beams to be used for the re-established connection.

The described techniques may improve efficiency and communications for communications using multiple TCI states and improve beam failure recovery. The described techniques may improve user experience through improved throughput, faster connection re-establishment, and improved power savings.

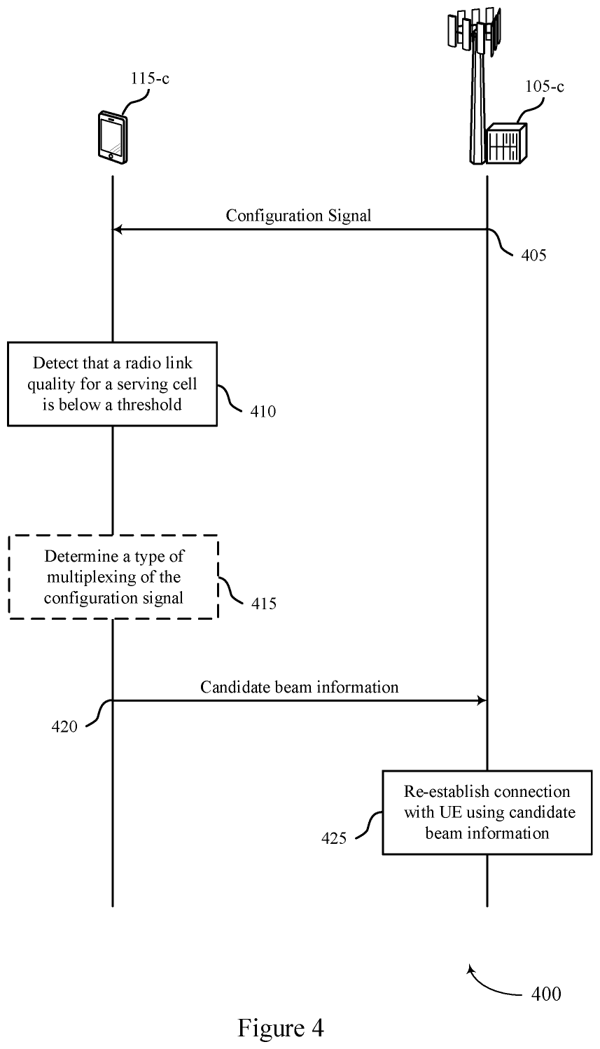

FIG. 4 shows an example of a process flow 400 that support new beam identification for PDCCH repetition. In some examples, the process flow 400 may implement aspects of wireless communications systems 100 and 200. The process flow 400 may include a base station 105-c and a UE 115-c, which may be examples of the corresponding devices described with reference to FIGS. 1-3

The base station 105-c may transmit a configuration signal 405 to the UE 115-b. In some examples, the configuration signal 405 may instruct the UE 115-c to provide an index for a corresponding serving cell with a radio link quality below a threshold radio link quality. In some examples, the configuration signal 405 includes a radio link quality threshold, Q_{out,LR}. The base station 105-c may transmit the configuration signal 405 using multiplexing techniques, such as TMD, FDM or SDM. In other examples, the configuration signal 405 may provide an indication of a multiplexing type.

In some examples, the configuration signal 405 may indicate, for a PCell or a PSCell, a configuration for PRACH transmission where each PRACH transmission occasion is associated with a new beam information which can be a pair of one or two RSs (such as SSB/CSI-RS). The configuration indication may be via an element PRACH-ResourceDedicatedBFR in RRC signaling. For a PRACH transmission in slot n and according to antenna port QCL-D parameters associated with a pair of periodic CSI-RS resource configuration or SS/PBCH block associated with the index q_{new} provided by higher layers, the UE 115-c may monitor the PDCCH for detection of a DCI format with cyclic redundancy check (CRC) scrambled by cell radio-network temporary identifier (C-RNTI) or modulation coding scheme (MCS)C-RNTI (MCS-C-RNTI) starting from slot n+4 within a window configured by the element BeamFailureRecoveryConfig. In some examples, the PDCCH is monitored in one CORESET through a link to a search space set provided by the element recoverySearchSpaceId, of one or two TCI-states or QCL assumptions depending on one or two new candidate beams (which may provide a TCI state or QCL assumptions) associated with q_{new}. In some other examples, the PDCCH is monitored in one SS set provided by the element recoverySearchSpaceId to be associated with one or two different CORESETs depending on one or two new candidate beams assumptions (which may provide a TCI state or QCL assumptions) associated with q_{new}. In some other examples, the PDCCH is monitored in one or two SS sets associated with corresponding CORESETs depending on one or two new candidate beams (which may provide a TCI state or QCL assumptions) associated with q_{new}.

At 410, the UE 115-c may detect that a radio link quality for a serving cell is below the radio link quality threshold, Q_{out,LR}. The UE 115-c may determine the radio link quality threshold from the configuration signal 405.

If there are two new candidate beams in the set q_{new} for a serving cell, the two new candidate beams can be received in a TDM manner, in an FDM manner, or in an SDM manner, or based on configuration to be received in an TDM, FDM, or SDM manner. For example, at 415, the UE 115-c may determine a type of multiplexing of the configuration signal, and send the candidate beam information 420 to the base station 105-c. The UE 115-c may send the candidate beam information 420 using the multiplexing type.

The UE 115-c may send candidate beam information 420 to the base station 105-c. The candidate beam information 420 may identify the new candidate beams. In some examples, the UE 115-c may send index information to the base station 105-c based on the radio link quality for the serving cell being below the threshold. The UE 115-c can provide index(es) for at least corresponding serving cell(s) with radio link quality worse than Q_{out,LR}, indication(s) of presence of the new beam information q_{new} for corresponding serving cell(s), and each index(es) in the set q_{new} for a periodic CSI-RS configuration or for a SS/PBCH block provided by higher layers, if any, for corresponding serving cell(s) as part of the candidate beam information 420.

At 425, the base station 105-c may re-establish the connection with the UE 115-c using one or more candidate beams indicated in the candidate beam information 420. The base station 105-b may use various metrics to select the one or more candidate beams to be used to re-establish the connection.

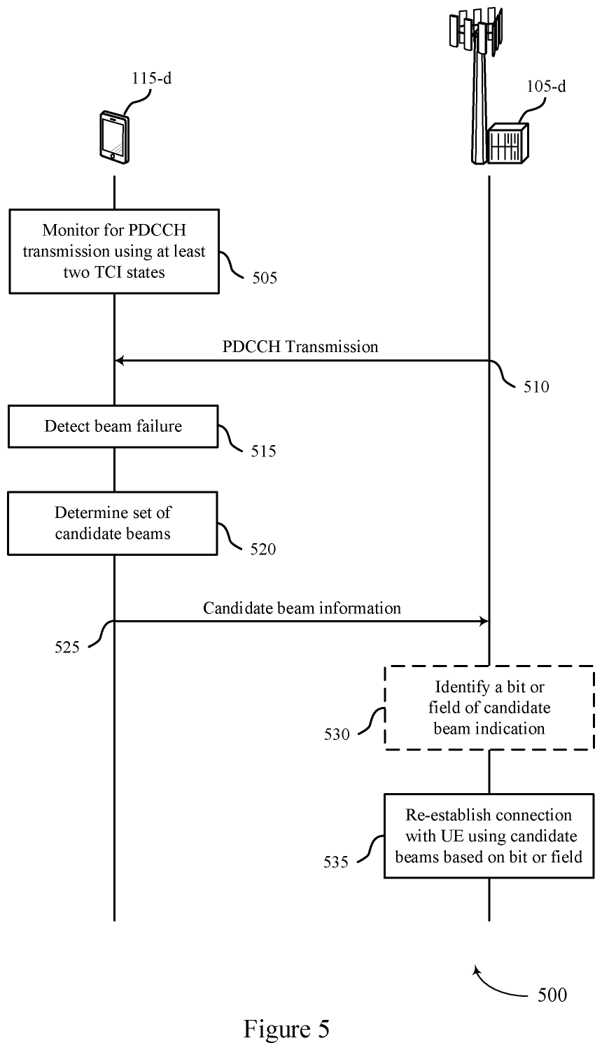

FIG. 5 shows an example of a process flow 500 that support new beam identification for PDCCH repetition. In some examples, the process flow 500 may implement aspects of wireless communications systems 100 and 200. The process flow 500 may include a base station 105-d and a UE 115-d, which may be examples of the corresponding devices described with reference to FIGS. 1-4. The UE 115-d and the base station 105-d may support a beam failure recovery MAC-CE for indicating one or two candidate RSs for each serving cell.

At 505, the UE 115-d may monitor for PDCCH transmissions using the TCI states. The UE 115-d may monitor for PDCCH transmissions 510 using at least one CORESET associated with the at least two TCI states, one search space set associated with at least two CORESETs, or two search space sets associated with two CORESETs each having an active TCI state. The base station 105-d may output one or more PDCCH transmissions 510. In some examples, the UE 115-d may monitor a first CORESET for the PDCCH transmission based at least in part on the at least two TCI states or a QCL assumption associated with the PRACH transmission. In some examples, the UE 115-d may monitor at least one search space set associated with at least one CORESET for the PDCCH transmission based at least in part on the indication of the set of candidate beams. In some other examples, the UE 115-d may receive a second indication of the at least one search space set. The at least one search space set may be based at least in part on at least one of the at least two TCI states or a QCL assumption associated with the PRACH transmission.

At 515, the UE 115-d may detect a beam failure of one or both of the beams. Based on detecting the beam failure, the UE 115-d may determine a set of candidate beams at 520. The UE 115-d may determine the set of candidate beams based on the pair of reference signals indicated in a configuration signal or from a list of a pair of reference signals. For example, the UE 115-d may use a list of the pair of RSs, where each pair of RSs is configured with either one or two TCI states, to determine a set of potential candidate beams for re-establishment of the connection with the base station 105-d.

The UE 115-d may output a candidate beam information 525 that informs the base station 105-d of the identity of a set of potential beams for re-establishing the connection. The indication may be in a MAC-CE or a PRACH transmission. In some other examples, the UE 115-d may set a field of the MAC-CE to indicate that the beam failure is detected for a serving cell. In some other examples, the UE 115-d may set a field of the MAC-CE to indicate a presence of a new beam information for a serving cell with beam failure event. In some examples, the UE 115-d may set a bit of the MAC-CE to indicate whether there are one or two reference signal identifications as the new beam information for a serving cell with beam failure event in the MAC-CE. In some other examples, the indication of the set of candidate beams further indicates at least one reference signal pair identification as the new beam information for a serving cell with beam failure event, where each pair identification may correspond to one or two RSs configured in the new candidate beam resource set (such as q1). In some examples where the new beam indication is sent via a PRACH transmission, the PRACH transmission occasion is associated with a pair of at least one RSs (such as SSB or CSI-RS).

At 530, the base station 105-d may identify a bit of a field of the candidate beam information 525. For example, the base station 105-d may identify a field of the MAC-CE that indicates that the beam failure was detected for a serving cell. In some other examples, the base station 105-d may identify a field of the MAC-CE that indicates a presence of a candidate reference signal identification for the serving cell with beam failure. In some other examples, the base station 105-d may determine a bit of the MAC-CE that indicates whether there are one or two reference signal identifications in the MAC-CE as the new beam information for the serving cell with beam failure. In some other examples, the indication of the set of candidate beams further indicates at least one candidate reference signal pair identification.

At 535, the base station 105-d may re-establish the connection with the UE 115-d using information from the candidate beam information 335. The base station 105-d may use various metrics to determine one or more candidate beams to be used for the re-established connection.

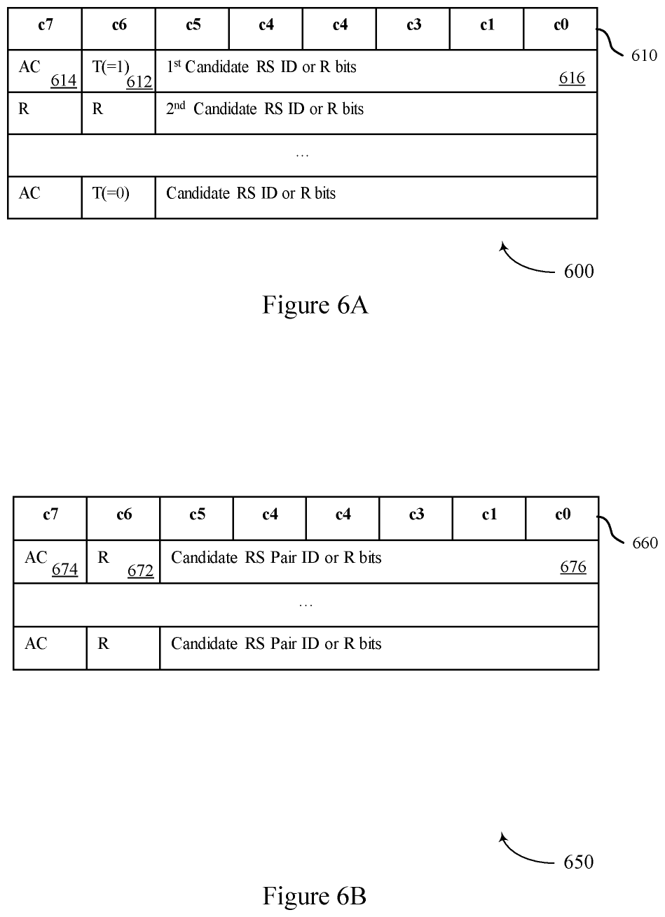

FIG. 6A shows an example diagram of a component carrier octet 600 that supports new beam identification for PDCCH repetition. The component carrier octet 600 may represent a MAC format that may be used to support beam failure recovery MAC-CE signaling. In some examples, component carrier octet 600 may be signaled by a UE to a base station. The component carrier octet 600 shows eight component carriers 610, c0-c7.

The component carrier octet 600 may be used to support beam failure recovery MAC-CE signaling. A cᵢ field 610 set to 1 (i=0, . . . 7) may indicate that the beam failure is detected for the i^{th} serving cell which is with ServCellIndex i, and there is at least one octet containing an AC field 614 for the i^{th} serving cell. The cᵢ field set to 0 may indicate that the beam failure is not detected for the i^{th} serving cell and there is no octet containing the AC field 614 for the serving cell. Octets containing the AC field 614, if present, are included in ascending order based on the ServCellIndex i.

The AC field 614 may indicate the presence of new beam information for the corresponding serving cell detected with beam failure. If at least one of the RSs is reported as the new beam information for the corresponding serving cell detected with beam failure, the AC field 614 is set to 1; otherwise, it is set to 0. If the AC field 614 is set to 1, the first RS, in the new beam information (for example, a Candidate RS ID field 616), is in the same octet of the AC field 614.

A T field 612 may further indicate whether there is one or two RS identifications (IDs) reported in the new beam information for the corresponding serving cell with a beam failure event. For the octet containing an AC field 614 for a serving cell with ServCellIndex i, if the field T 612 is set to 1, there are two RS IDs reported in the new beam information for the corresponding serving cell with the beam failure event, and if the field T 612 is set to 0, there is one RS ID reported in the new beam information for the corresponding serving cell with the beam failure event. If the T field 612 is set to 1, the second RS in the new beam information is in the next octet to the octet containing the AC field 614.

FIG. 6B shows an example diagram of a component carrier octet 650 that supports new beam identification for PDCCH repetition. The component carrier octet 650 may represent a MAC format that may be used to support beam failure recovery MAC-CE signaling. In some examples, component carrier octet 650 may be signaled by a UE to a base station. The component carrier octet 600 shows eight component carriers 660, c0-c7.

The component carrier octet 650 may be used to support beam failure recovery MAC-CE signaling. The component carrier octet 650 shows an alternative MAC-CE format than the component carrier octet 600, including an AC field 674, a reserved field 627, and a candidate RS pair ID field 676. The component carrier octet 650 includes the cᵢ fields 610, which may be set to 1 to indicate a beam failure is detected and the octet 660 contains an AC field 614 for that serving cell and 0 to indicate a beam failure is not detected and the octet 660 does not contain an AC field 614 for that serving cell. The AC field 674 indicates whether there is a candidate RS pair ID reported in the same octet 660. The candidate RS pair ID or R bits 676 may indicate that the new beam information corresponds to one or two RSs.

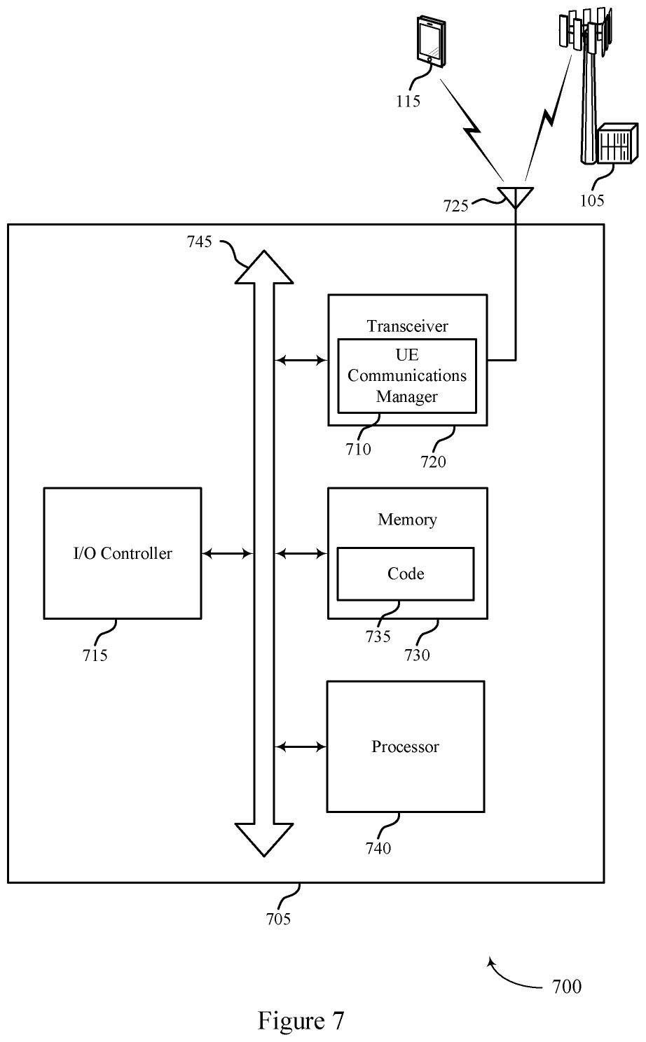

FIG. 7 shows a diagram of an example system 700 including a device 705 that supports new beam identification for PDCCH repetition in accordance with aspects of the present disclosure. The device 705 may be an example of or include the components of a UE 115 as described herein. The device 705 may include components for bi-directional voice and data communications including components for transmitting and receiving communications, including a UE communications manager 710, an I/O controller 715, a transceiver 720, an antenna 725, memory 730, and a processor 740. These components may be in electronic communication via one or more buses (such as bus 745).

The UE communications manager 710 may be an example of aspects of the UE communications manager 160 as described herein. The UE communications manager 710 may be or include a UE communications manager 160.

The UE communications manager 710 may receive a configuration signal identifying a resource set that includes a pair of reference signals, monitor for a PDCCH transmission using at least two TCI states, detect a beam failure according to the resource set and based on the monitoring, and determine a set of candidate beams based on detecting the beam failure.

In some other examples, the UE communications manager 710 also may receive a configuration signal, detect that a first radio link quality for a first serving cell is below a threshold radio link quality and provide an index for the first serving cell based on the configuration signal and detecting that the first radio link quality is below the threshold radio link quality. In response to detecting that the first radio link quality for the first serving cell is below the threshold radio link quality, the UE communications manager 710 may transmit information related to one or more candidate beams based on the received configuration signal.

In some other examples, the UE communications manager 710 also may monitor a PDCCH transmission using at least two TCI states, detect a beam failure according to a resource set and based on the monitoring, determine a set of candidate beams based on detecting the beam failure, and transmit an indication of the set of candidate beams in a MAC-CE or a PRACH transmission.

The UE communications manager 710 may receive a configuration signal identifying a resource set that includes a pair of reference signals. In some examples, receiving the configuration signal further includes receiving the configuration signal using a type of multiplexing.

In some examples, the UE communications manager 710 may detect a beam failure according to the resource set and based on the monitoring. In some examples, the UE communications manager 710 may determine a set of candidate beams based on detecting the beam failure. In some examples, the UE communications manager 710 may detect that a first radio link quality for a first serving cell is below a threshold radio link quality.

In some examples, the UE communications manager 710 may provide an index for the first serving cell based on the configuration signal and detecting that the first radio link quality is below the threshold radio link quality.

In some examples, the UE communications manager 710 may in response to detecting that the first radio link quality for the first serving cell is below the threshold radio link quality, transmitting information related to one or more candidate beams based on the received configuration signal.

In some examples, the UE communications manager 710 may transmit the set of candidate beams to a base station based on determining the set of candidate beams.

In some examples, the UE communications manager 710 may monitor at least one CORESET associated with the at least two TCI states, monitoring one search space set associated with at least two CORESETs, or monitoring two search space sets associated with two CORESETs each having an active TCI state.

In some examples, transmitting the information related to the one or more candidate beams further includes transmitting the information using the type of multiplexing. For example, receiving the configuration signal may further include receiving the configuration signal using TDM. In some other examples, transmitting the information related to the one or more candidate beams further includes transmitting the information using TDM. In some other examples, receiving the configuration signal further includes receiving the configuration signal using FDM. In some other examples, transmitting the information related to the one or more candidate beams further includes transmitting the information using FDM.

In some examples, the UE communications manager 710 may set a bit of the MAC-CE to indicate whether there are one or two reference signal identifications in the MAC-CE. In some other examples, the UE communications manager 710 may set a field of the MAC-CE to indicate that the beam failure is detected. In some other examples, the UE communications manager 710 may set a field of the MAC-CE to indicate a presence of a candidate reference signal identification.

In some examples, the UE communications manager 710 may monitor a first CORESET for the PDCCH transmission based on the at least two TCI states or a quasi co-location assumption associated with the PRACH transmission. In some other examples, the UE communications manager 710 may monitor at least one search space set associated with at least one CORESET for the PDCCH transmission based on the indication of the set of candidate beams.

In some examples, the UE communications manager 710 may receive a second indication of the at least one search space set.

In some cases, the pair of reference signals includes periodic CSI-RS resource configuration indexes, a set of synchronization signal block indexes, or a set of PBCH block indexes. In some cases, each of the pair of reference signals are configured with either one or both of the at least two TCI states. In some cases, the indication of the set of candidate beams further indicates at least one candidate reference signal pair identification. In some cases, the PRACH transmission is associated with a pair of at least one SSB or CSI-RS.

In some cases, the at least one search space set is based on at least one of the at least two TCI states or a quasi co-location assumption associated with the PRACH transmission.

The UE communications manager 710, or its sub-components, may be implemented in hardware, code (such as software or firmware) executed by a processor, or any combination thereof. If implemented in code executed by a processor, the functions of the UE communications manager 710, or its sub-components may be executed by a general-purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described in the present disclosure.

The UE communications manager 710, or its sub-components, may be physically located at various positions, including being distributed such that portions of functions are implemented at different physical locations by one or more physical components. In some examples, the UE communications manager 710, or its sub-components, may be a separate and distinct component in accordance with various aspects of the present disclosure. In some examples, the UE communications manager 710, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

In some examples, the UE communications manager 710, when functioning as a processor or a processing system, may obtain the signaling from a receiver, such as the transceiver 720, using a first interface and may output signaling for transmission via a transmitter, such as the transceiver 720, using a second interface.

The I/O controller 715 may manage input and output signals for the device 705. The I/O controller 715 also may manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 also may include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include random access memory (RAM) and read-only memory (ROM). The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (such as the memory 730) to cause the device 705 to perform various functions (such as functions or tasks supporting new beam identification for PDCCH repetition).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (such as when compiled and executed) to perform functions described herein.

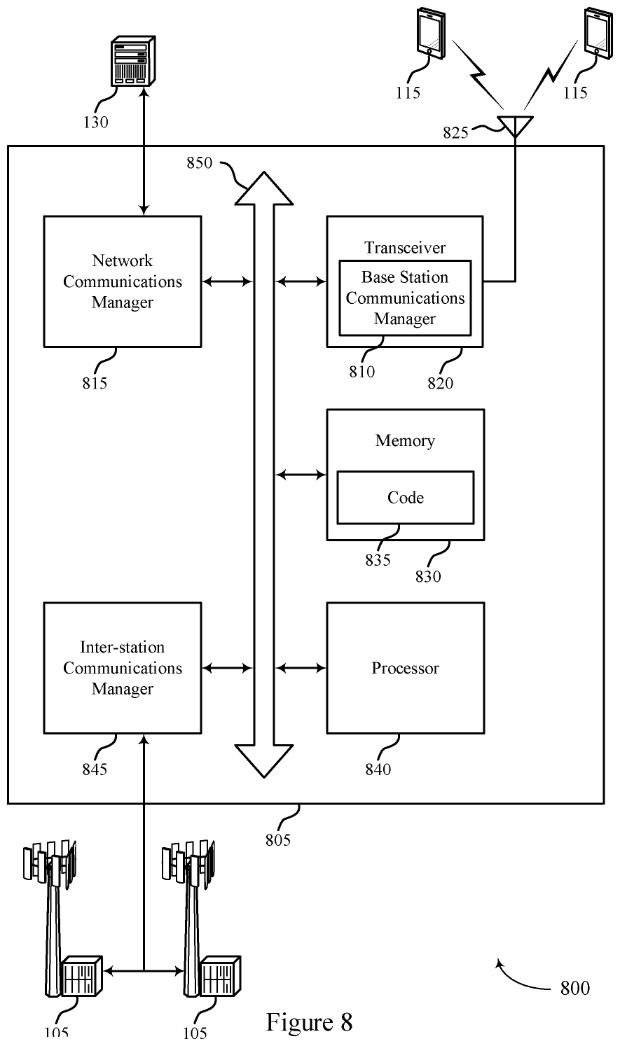

FIG. 8 shows a diagram of an example system 800 including a device 805 that supports new beam identification for PDCCH repetition in accordance with aspects of the present disclosure. The device 805 may be an example of or include the components a base station 105 as described herein. The device 805 may include components for bi-directional voice and data communications including components for transmitting and receiving communications, including a base station communications manager 810, a network communications manager 815, a transceiver 820, an antenna 825, memory 830, a processor 840, and an inter-station communications manager 845. These components may be in electronic communication via one or more buses (such as bus 850).

The base station communications manager 810 may be an example of aspects of the base station communications manager 150 as described herein. The base station communications manager 810 may be or include a base station communications manager 150.

The base station communications manager 810 may transmit a configuration signal to a UE identifying a resource set that includes a pair of reference signals for determining a set of candidate beams upon detection of a beam failure and receive the set of candidate beams from the UE based on determining the set of candidate beams upon detection of the beam failure at the UE.

The base station communications manager 810 also may transmit a configuration signal that instructs a UE to provide an index for a corresponding serving cell with a radio link quality below a threshold radio link quality and receive information related to one or more candidate beams corresponding to a first serving cell based on the configuration signal, where a first radio link quality for the first serving cell is below the threshold radio link quality.

The base station communications manager 810 also may receive an indication of a set of candidate beams for connection reestablishment with a UE in a MAC-CE or a PRACH transmission and re-establish a connection with the UE using the set of candidate beams.

The base station communications manager 810 may transmit a configuration signal to a UE identifying a resource set that includes a pair of reference signals for determining a set of candidate beams upon detection of a beam failure and receive the set of candidate beams from the UE based on determining the set of candidate beams upon detection of the beam failure at the UE.

The base station communications manager 810 may transmit a configuration signal that instructs a UE to provide an index for a corresponding serving cell with a radio link quality below a threshold radio link quality and receive information related to one or more candidate beams corresponding to a first serving cell based on the configuration signal, where a first radio link quality for the first serving cell is below the threshold radio link quality.

In some examples, transmitting the configuration signal further includes transmitting the configuration signal using a type of multiplexing. In some other examples, transmitting the configuration signal further includes transmitting the configuration signal using TDM. In some examples, transmitting the configuration signal further includes transmitting the configuration signal using FDM.

In some examples, receiving the information related to the one or more candidate beams further includes receiving the information using the type of multiplexing. In some other examples, receiving the information related to the one or more candidate beams further includes receiving the information using TDM. In some examples, receiving the information related to the one or more candidate beams further includes receiving the information using FDM.

In some examples, the base station communications manager 810 may identify a bit of the MAC-CE to determine whether there are one or two reference signal identifications in the MAC-CE. In some examples, the base station communications manager 810 may identify a field of the MAC-CE to determine that the UE detected a beam failure. In some examples, the base station communications manager 810 may identify a field of the MAC-CE that indicates a presence of a candidate reference signal identification.

In some examples, the base station communications manager 810 may transmit an indication of at least one search space set associated with at least one CORESET for a PDCCH transmission. In some cases, the pair of reference signals includes periodic CSI-RS resource configuration indexes, a set of synchronization signal block indexes, or a set of PBCH block indexes. In some cases, each of the pair of reference signals are configured with either one or both of at least two TCI states.

In some cases, the indication of the set of candidate beams further indicates at least one candidate reference signal pair identification. In some cases, the PRACH transmission is associated with a pair of at least one SSB or CSI reference signal. In some cases, the at least one search space set is based on at least one of a TCI state or a quasi co-location assumption associated with the PRACH transmission.

In some examples, the base station communications manager 810, when functioning as a processor or a processing system, may obtain the signaling from a receiver, such as the transceiver 820, using a second interface and may output signaling for transmission via a transmitter, such as the transceiver 820, using a first interface.

The base station communications manager 810, or its sub-components, may be implemented in hardware, code (such as software or firmware) executed by a processor, or any combination thereof. If implemented in code executed by a processor, the functions of the base station communications manager 810, or its sub-components may be executed by a general-purpose processor, a DSP, an ASIC, an FPGA or other PLD, discrete gate or transistor logic, discrete hardware components, or any combination thereof designed to perform the functions described in the present disclosure.

The network communications manager 815 may manage communications with the core network (such as via one or more wired backhaul links). For example, the network communications manager 815 may manage the transfer of data communications for client devices, such as one or more UEs 115.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 also may include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM, ROM, or a combination thereof. The memory 830 may store computer-readable code 835 including instructions that, when executed by a processor (such as the processor 840) cause the device to perform various functions described herein. In some cases, the memory 830 may contain, among other things, a BIOS which may control basic hardware or software operation such as the interaction with peripheral components or devices.

The processor 840 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some cases, a memory controller may be integrated into processor 840. The processor 840 may be configured to execute computer-readable instructions stored in a memory (such as the memory 830) to cause the device 805 to perform various functions (such as functions or tasks supporting new beam identification for PDCCH repetition).

The inter-station communications manager 845 may manage communications with other base station 105, and may include a controller or scheduler for controlling communications with UEs 115 in cooperation with other base stations 105. For example, the inter-station communications manager 845 may coordinate scheduling for transmissions to UEs 115 for various interference mitigation techniques such as beamforming or joint transmission. In some examples, the inter-station communications manager 845 may provide an X2 interface within an LTE/LTE-A wireless communication network technology to provide communication between base stations 105.

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (such as when compiled and executed) to perform functions described herein.

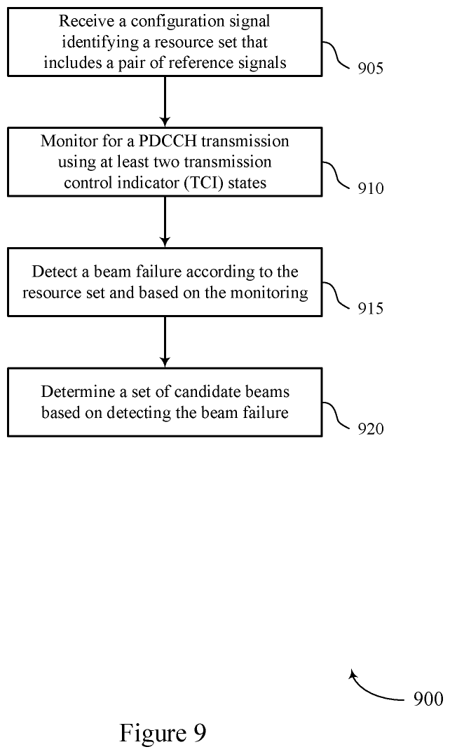

FIG. 9 shows a flowchart illustrating an example method 900 that supports new beam identification for PDCCH repetition. The operations of method 900 may be implemented by a UE 115 or its components as described herein. For example, the operations of method 900 may be performed by a UE communications manager as described with reference to FIGS. 1 and 7. In some examples, a UE may execute a set of instructions to control the functional elements of the UE to perform the functions described below. Additionally, or alternatively, a UE may perform aspects of the functions described below using special-purpose hardware.

At 905, the UE may receive a configuration signal identifying a resource set that includes a pair of reference signals. The operations of 905 may be performed according to the methods described herein. In some examples, aspects of the operations of 905 may be performed by a UE communications manager as described with reference to FIGS. 1 and 7.

At 910, the UE may monitor for a PDCCH transmission using at least two TCI states. The operations of 910 may be performed according to the methods described herein. In some examples, aspects of the operations of 910 may be performed by a UE communications manager as described with reference to FIGS. 1 and 7.

At 915, the UE may detect a beam failure according to the resource set and based on the monitoring. The operations of 915 may be performed according to the methods described herein. In some examples, aspects of the operations of 915 may be performed by a UE communications manager as described with reference to FIGS. 1 and 7.

At 920, the UE may determine a set of candidate beams based on detecting the beam failure. The operations of 920 may be performed according to the methods described herein. In some examples, aspects of the operations of 920 may be performed by a UE communications manager as described with reference to FIGS. 1 and 7.

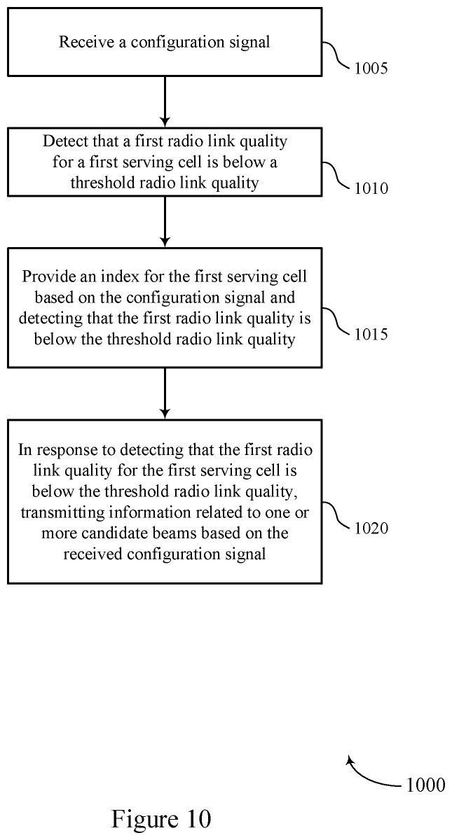

FIG. 10 shows a flowchart illustrating an example method 1000 that supports new beam identification for PDCCH repetition. The operations of method 1000 may be implemented by a UE 115 or its components as described herein. For example, the operations of method 1000 may be performed by a UE communications manager as described with reference to FIGS. 1 and 7. In some examples, a UE may execute a set of instructions to control the functional elements of the UE to perform the functions described below. Additionally, or alternatively, a UE may perform aspects of the functions described below using special-purpose hardware.

At 1005, the UE may receive a configuration signal. The operations of 1005 may be performed according to the methods described herein. In some examples, aspects of the operations of 1005 may be performed by a UE communications manager as described with reference to FIGS. 1 and 7.

At 1010, the UE may detect that a first radio link quality for a first serving cell is below a threshold radio link quality. The operations of 1010 may be performed according to the methods described herein. In some examples, aspects of the operations of 1010 may be performed by a UE communications manager as described with reference to FIGS. 1 and 7.

At 1015, the UE may provide an index for the first serving cell based on the configuration signal and detecting that the first radio link quality is below the threshold radio link quality. The operations of 1015 may be performed according to the methods described herein. In some examples, aspects of the operations of 1015 may be performed by a UE communications manager as described with reference to FIGS. 1 and 7.

At 1020, the UE may in response to detecting that the first radio link quality for the first serving cell is below the threshold radio link quality, transmitting information related to one or more candidate beams based on the received configuration signal. The operations of 1020 may be performed according to the methods described herein. In some examples, aspects of the operations of 1020 may be performed by a UE communications manager as described with reference to FIGS. 1 and 7.

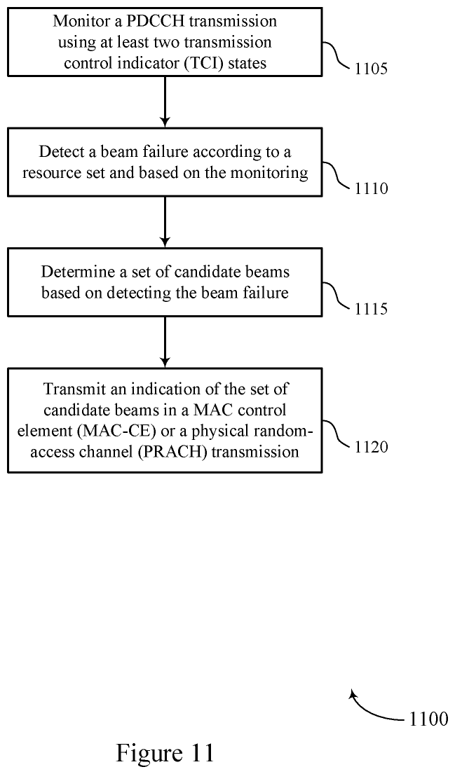

FIG. 11 shows a flowchart illustrating an example method 1100 that supports new beam identification for PDCCH repetition. The operations of method 1100 may be implemented by a UE 115 or its components as described herein. For example, the operations of method 1100 may be performed by a UE communications manager as described with reference to FIGS. 1 and 7. In some examples, a UE may execute a set of instructions to control the functional elements of the UE to perform the functions described below. Additionally, or alternatively, a UE may perform aspects of the functions described below using special-purpose hardware.

At 1105, the UE may monitor a PDCCH transmission using at least two TCI states. The operations of 1105 may be performed according to the methods described herein. In some examples, aspects of the operations of 1105 may be performed by a UE communications manager as described with reference to FIGS. 1 and 7.

At 1110, the UE may detect a beam failure according to a resource set and based on the monitoring. The operations of 1110 may be performed according to the methods described herein. In some examples, aspects of the operations of 1110 may be performed by a UE communications manager as described with reference to FIGS. 1 and 7.

At 1115, the UE may determine a set of candidate beams based on detecting the beam failure. The operations of 1115 may be performed according to the methods described herein. In some examples, aspects of the operations of 1115 may be performed by a UE communications manager as described with reference to FIGS. 1 and 7.

At 1120, the UE may transmit an indication of the set of candidate beams in a MAC-CE or a PRACH transmission. The operations of 1120 may be performed according to the methods described herein. In some examples, aspects of the operations of 1120 may be performed by a UE communications manager as described with reference to FIGS. 1 and 7.

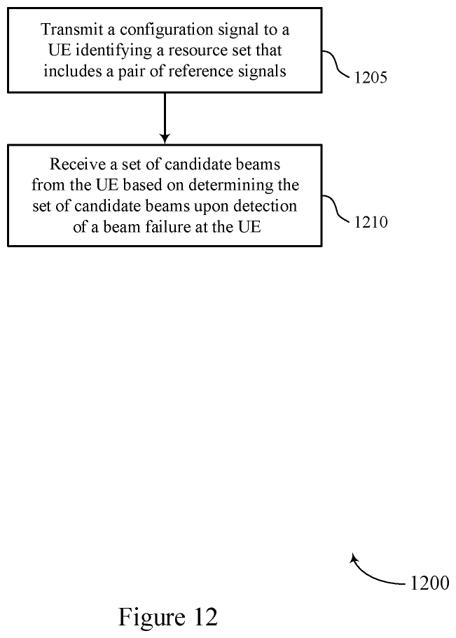

FIG. 12 shows a flowchart illustrating an example method 1200 that supports new beam identification for PDCCH repetition. The operations of method 1200 may be implemented by a base station 105 or its components as described herein. For example, the operations of method 1200 may be performed by a base station communications manager as described with reference to FIGS. 1 and 8. In some examples, a base station may execute a set of instructions to control the functional elements of the base station to perform the functions described below. Additionally, or alternatively, a base station may perform aspects of the functions described below using special-purpose hardware.

At 1205, the base station may transmit a configuration signal to a UE identifying a resource set that includes a pair of reference signals for determining a set of candidate beams upon detection of a beam failure. The operations of 1205 may be performed according to the methods described herein. In some examples, aspects of the operations of 1205 may be performed by a base station communications manager as described with reference to FIGS. 1 and 8.

At 1210, the base station may receive the set of candidate beams from the UE based on determining the set of candidate beams upon detection of the beam failure at the UE. The operations of 1210 may be performed according to the methods described herein. In some examples, aspects of the operations of 1210 may be performed by a base station communications manager as described with reference to FIGS. 1 and 8.

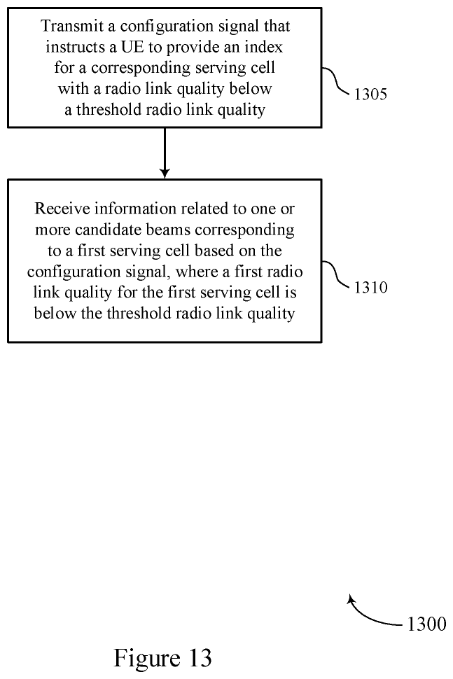

FIG. 13 shows a flowchart illustrating an example method 1300 that supports new beam identification for PDCCH repetition. The operations of method 1300 may be implemented by a base station 105 or its components as described herein. For example, the operations of method 1300 may be performed by a communications manager as described with reference to FIGS. 1 and 8. In some examples, a base station may execute a set of instructions to control the functional elements of the base station to perform the functions described below. Additionally, or alternatively, a base station may perform aspects of the functions described below using special-purpose hardware.

At 1305, the base station may transmit a configuration signal that instructs a UE to provide an index for a corresponding serving cell with a radio link quality below a threshold radio link quality. The operations of 1305 may be performed according to the methods described herein. In some examples, aspects of the operations of 1305 may be performed by a base station communications manager as described with reference to FIGS. 1 and 8.

At 1310, the base station may receive information related to one or more candidate beams corresponding to a first serving cell based on the configuration signal, where a first radio link quality for the first serving cell is below the threshold radio link quality. The operations of 1310 may be performed according to the methods described herein. In some examples, aspects of the operations of 1310 may be performed by a base station communications manager as described with reference to FIGS. 1 and 8.

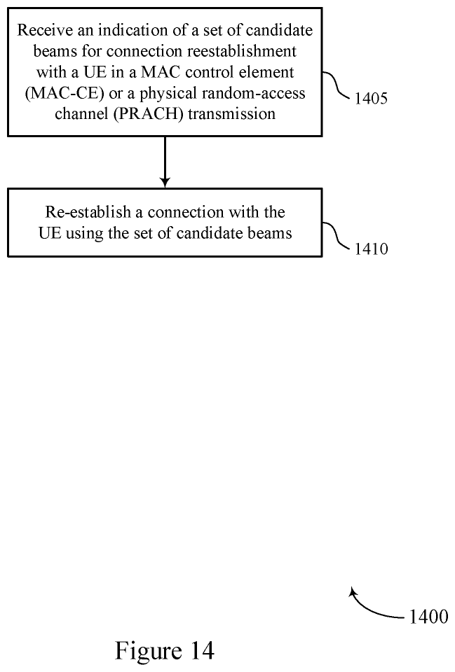

FIG. 14 shows a flowchart illustrating an example method 1400 that supports new beam identification for PDCCH repetition. The operations of method 1400 may be implemented by a base station 105 or its components as described herein. For example, the operations of method 1400 may be performed by a communications manager as described with reference to FIGS. 1 and 8. In some examples, a base station may execute a set of instructions to control the functional elements of the base station to perform the functions described below. Additionally, or alternatively, a base station may perform aspects of the functions described below using special-purpose hardware.

At 1405, the base station may receive an indication of a set of candidate beams for connection reestablishment with a UE in a MAC-CE or a PRACH transmission. The operations of 1405 may be performed according to the methods described herein. In some examples, aspects of the operations of 1405 may be performed by a base station communications manager as described with reference to FIGS. 1 and 8.

At 1410, the base station may re-establish a connection with the UE using the set of candidate beams. The operations of 1410 may be performed according to the methods described herein. In some examples, aspects of the operations of 1410 may be performed by a base station communications manager as described with reference to FIGS. 1 and 8.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a DSP, an ASIC, an FPGA or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some examples be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some examples, the actions recited in the claims can be performed in a different order and still achieve desirable results.

What is claimed is:

1. An apparatus for wireless communication at an apparatus of a user equipment (UE), comprising:
a first interface configured to:
obtain a configuration signal identifying a resource set that includes a pair of reference signals;
a processing system configured to:
monitor for a physical downlink control channel (PDCCH) transmission using at least two transmission control indicator (TCI) states;
detect a beam failure according to the resource set and based at least in part on the monitoring; and
determine a set of candidate beams based at least in part on detecting the beam failure.

2. The apparatus of claim 1, further comprising:
the first interface or a second interface configured to:
output the set of candidate beams for transmission to a base station based at least in part on determining the set of candidate beams.

3. The apparatus of claim 1, wherein the pair of reference signals comprises periodic channel state information reference signals (CSI-RS) resource configuration indexes, a set of synchronization signal block indexes, or a set of physical broadcast channel (PBCH) block indexes.

4. The apparatus of claim 1, wherein each of the pair of reference signals are configured with either one or both of the at least two TCI states.

5. The apparatus of claim 1, wherein the processing system is further configured to:
monitor at least one control resource set (CORESET) associated with the at least two TCI states, monitoring one search space set associated with at least two CORESETs, or monitoring two search space sets associated with two CORESETs each having an active TCI state.

6. The apparatus of claim 1, wherein the pair of reference signals is for determining the set of candidate beams upon detection of the beam failure.

7. An apparatus for wireless communication at a user equipment (UE), comprising:
a first interface configured to:
obtain a configuration signal;
a processing system configured to:
detect that a first radio link quality for a first serving cell is below a threshold radio link quality; and
provide an index for the first serving cell based at least in part on the configuration signal and detecting that the first radio link quality is below the threshold radio link quality; and
the first interface or a second interface configured to:
in response to detecting that the first radio link quality for the first serving cell is below the threshold radio link quality, output information related to one or more candidate beams for transmission, wherein the one or more candidate beams is based at least in part on the received configuration signal.

8. The apparatus of claim 7, wherein:
the first interface configured to obtain the configuration signal is further configured to obtain the configuration signal using a type of multiplexing; and
the first interface or the second interface configured to output the information related to the one or more candidate beams is further configured to output the information using the type of multiplexing.

9. The apparatus of claim 7, wherein:
the first interface configured to obtain the configuration signal is further configured to obtain the configuration signal using time division multiplexing (TDM); and
the first interface or the second interface configured to output the information related to the one or more candidate beams is further configured to output the information using TDM.

10. The apparatus of claim 7, wherein:
the first interface configured to obtain the configuration signal is further configured to obtain the configuration signal using frequency division multiplexing (FDM);
and the first interface or the second interface configured to output the information related to the one or more candidate beams is further configured to output the information using FDM.

11. An apparatus for wireless communication at a user equipment (UE), comprising:
a processing system configured to:
monitor a physical downlink control channel (PDCCH) transmission using at least two transmission control indicator (TCI) states;
detect a beam failure according to a resource set and based at least in part on the monitoring; and
determine a set of candidate beams based at least in part on detecting the beam failure; and
a first interface configured to:
output an indication of the set of candidate beams for transmission in a media access control (MAC) control element (MAC-CE) or a physical random-access channel (PRACH).

12. The apparatus of claim 11, wherein the processing system is further configured to:
set a bit of the MAC-CE to indicate whether there are one or two reference signal identifications in the MAC-CE.

13. The apparatus of claim 11, wherein the processing system is further configured to:
set a field of the MAC-CE to indicate that the beam failure is detected.

14. The apparatus of claim 11, wherein the processing system is further configured to:
set a field of the MAC-CE to indicate a presence of a candidate reference signal identification.

15. The apparatus of claim 11, wherein the indication of the set of candidate beams further indicates at least one candidate reference signal pair identification.

16. The apparatus of claim 11, wherein the PRACH transmission is associated with a pair of at least one synchronization signal block (SSB) or channel state information (CSI) reference signal (CSI-RS).

17. The apparatus of claim 16, wherein the processing system is further configured to:
monitor a first control resource set (CORESET) for the PDCCH transmission based at least in part on the at least two TCI states or a quasi co-location assumption associated with the PRACH.

18. The apparatus of claim 16, wherein the processing system is further configured to:
monitor at least one search space set associated with at least one control resource set (CORESET) for the PDCCH transmission based at least in part on the indication of the set of candidate beams.

19. The apparatus of claim 18, further comprising:
the first interface or a second interface configured to:
obtain a second indication of the at least one search space set.

20. The apparatus of claim 18, wherein the at least one search space set is based at least in part on at least one of the at least two TCI states or a quasi co-location assumption associated with the PRACH transmission.

21. An apparatus for wireless communication at a base station (BS), comprising:
a first interface configured to:
output a configuration signal for transmission to a user equipment (UE) identifying a resource set that includes a pair of reference signals; and
the first interface or a second interface configured to:
obtain a set of candidate beams from the UE based at least in part on determining the set of candidate beams upon detection of a beam failure at the UE.

22. The apparatus of claim 21, further comprising:
a processing system configured to:
re-establish a connection with the UE using the set of candidate beams.

23. The apparatus of claim 21, wherein the pair of reference signals comprises periodic channel state information reference signal (CSI-RS) resource configuration indexes, a set of synchronization signal block indexes, or a set of physical broadcast channel (PBCH) block indexes.

24. The apparatus of claim 21, wherein each of the pair of reference signals are configured with either one or both of at least two transmission control indicator (TCI) states.

25. The apparatus of claim 21, wherein the pair of reference signals is for determining the set of candidate beams upon detection of the beam failure.

26. An apparatus for wireless communication at a base station (BS), comprising:
a first interface configured to:
output a configuration signal for transmission that instructs a user equipment (UE) to provide an index for a corresponding serving cell with a radio link quality below a threshold radio link quality; and
the first interface or a second interface configured to:
obtain information related to one or more candidate beams corresponding to a first serving cell based at least in part on the configuration signal, wherein a first radio link quality for the first serving cell is below the threshold radio link quality.

27. The apparatus of claim 26, wherein:
the first interface configured to output the configuration signal is further configured to output the configuration signal using a type of multiplexing; and
the first interface or the second interface configured to obtain the information related to the one or more candidate beams is further configured to obtain the information using the type of multiplexing.

28. The apparatus of claim 26, wherein:
the first interface configured to output the configuration signal is further configured to output the configuration signal using time division multiplexing (TDM); and
the first interface or the second interface configured to obtain the information related to the one or more candidate beams is further configured to obtain the information using TDM.

29. The apparatus of claim 26, wherein:
the first interface configured to output the configuration signal is further configured to output the configuration signal using frequency division multiplexing (FDM); and
the first interface or the second interface configured to obtain the information related to the one or more candidate beams is further configured to obtain the information using FDM.

30. An apparatus for wireless communication at a base station (BS), comprising:
a first interface configured to:
obtain an indication of a set of candidate beams for connection reestablishment with a user equipment (UE) in a media access control (MAC) control element (MAC-CE) or a physical random-access channel (PRACH) transmission; and
a processing system configured to:
re-establish a connection with the UE using the set of candidate beams.

31. The apparatus of claim 30, wherein the processing system is further configured to:
identify a bit of the MAC-CE to determine whether there are one or two reference signal identifications in the MAC-CE.

32. The apparatus of claim 30, wherein the processing system is further configured to:
identify a field of the MAC-CE to determine that the UE detected a beam failure.

33. The apparatus of claim 30, wherein the processing system is further configured to:
identify a field of the MAC-CE that indicates a presence of a candidate reference signal identification.

34. The apparatus of claim 30, wherein the indication of the set of candidate beams further indicates at least one candidate reference signal pair identification.

35. The apparatus of claim 30, wherein the PRACH transmission is associated with a pair of at least one synchronization signal block (SSB) or channel state information (CSI) reference signal.

36. The apparatus of claim 30, wherein the first interface is further configured to:
output an indication of at least one search space set for transmission, wherein the at least one search space is associated with at least one control resource set (CORESET) for a physical downlink control channel (PDCCH) transmission.

37. The apparatus of claim 36, wherein the at least one search space set is based at least in part on at least one of a transmission control indicator (TCI) state or a quasi co-location assumption associated with the PRACH transmission.

38. A method for wireless communication at an apparatus of a user equipment (UE), comprising:
receiving a configuration signal identifying a resource set that includes a pair of reference signals;
monitoring for a physical downlink control channel (PDCCH) transmission using at least two transmission control indicator (TCI) states;
detecting a beam failure according to the resource set and based at least in part on the monitoring; and
determining a set of candidate beams based at least in part on detecting the beam failure.

39. The method of claim 38, further comprising:
transmitting the set of candidate beams to a base station based at least in part on determining the set of candidate beams.

40. The method of claim 38, wherein the pair of reference signals comprises periodic channel state information reference signals (CSI-RS) resource configuration indexes, a set of synchronization signal block indexes, or a set of physical broadcast channel (PBCH) block indexes.

41. The method of claim 38, wherein each of the pair of reference signals are configured with either one or both of the at least two TCI states.

42. The method of claim 38, wherein monitoring the PDCCH transmission further comprises:
monitoring at least one control resource set (CORESET) associated with the at least two TCI states, monitoring one search space set associated with at least two CORESETs, or monitoring two search space sets associated with two CORESETs each having an active TCI state.

43. The method of claim 38, wherein the pair of reference signals is for determining the set of candidate beams upon detection of the beam failure.

44. A method for wireless communication at an apparatus of a user equipment (UE), comprising:
receiving a configuration signal;
detecting that a first radio link quality for a first serving cell is below a threshold radio link quality;
providing an index for the first serving cell based at least in part on the configuration signal and detecting that the first radio link quality is below the threshold radio link quality; and
in response to detecting that the first radio link quality for the first serving cell is below the threshold radio link quality, transmitting information related to one or more candidate beams based at least in part on the received configuration signal.

45. The method of claim 44, wherein:
receiving the configuration signal further comprises receiving the configuration signal using a type of multiplexing; and
transmitting the information related to the one or more candidate beams further comprises transmitting the information using the type of multiplexing.

46. The method of claim 44, wherein:
receiving the configuration signal further comprises receiving the configuration signal using time division multiplexing (TDM); and
transmitting the information related to the one or more candidate beams further comprises transmitting the information using TDM.

47. The method of claim 44, wherein:
receiving the configuration signal further comprises receiving the configuration signal using frequency division multiplexing (FDM); and
transmitting the information related to the one or more candidate beams further comprises transmitting the information using FDM.

48. A method for wireless communication at an apparatus of a user equipment (UE), comprising:
monitoring a physical downlink control channel (PDCCH) transmission using at least two transmission control indicator (TCI) states;
detecting a beam failure according to a resource set and based at least in part on the monitoring;
determining a set of candidate beams based at least in part on detecting the beam failure; and
transmitting an indication of the set of candidate beams in a media access control (MAC) control element (MAC-CE) or a physical random-access channel (PRACH) transmission.

49. The method of claim 48, further comprising:
setting a bit of the MAC-CE to indicate whether there are one or two reference signal identifications in the MAC-CE.

50. The method of claim 48, further comprising:
setting a field of the MAC-CE to indicate that the beam failure is detected.

51. The method of claim 48, further comprising:
setting a field of the MAC-CE to indicate a presence of a candidate reference signal identification.

52. The method of claim 48, wherein the indication of the set of candidate beams further indicates at least one candidate reference signal pair identification.

53. The method of claim 48, wherein the PRACH transmission is associated with a pair of at least one synchronization signal block (SSB) or channel state information (CSI) reference signal (CSI-RS).

54. The method of claim 53, further comprising:
monitoring a first control resource set (CORESET) for the PDCCH transmission based at least in part on the at least two TCI states or a quasi co-location assumption associated with the PRACH transmission.

55. The method of claim 53, further comprising:
monitoring at least one search space set associated with at least one control resource set (CORESET) for the PDCCH transmission based at least in part on the indication of the set of candidate beams.

56. The method of claim 55, further comprising:
receiving a second indication of the at least one search space set.

57. The method of claim 55, wherein the at least one search space set is based at least in part on at least one of the at least two TCI states or a quasi co-location assumption associated with the PRACH transmission.

58. A method for wireless communication at an apparatus of a base station, comprising:
transmitting a configuration signal to a user equipment (UE) identifying a resource set that includes a pair of reference signals; and
receiving a set of candidate beams from the UE based at least in part on determining the set of candidate beams upon detection of a beam failure at the UE.

59. The method of claim 58, further comprising:
re-establishing a connection with the UE using the set of candidate beams.

60. The method of claim 58, wherein the pair of reference signals comprises periodic channel state information reference signal (CSI-RS) resource configuration indexes, a set of synchronization signal block indexes, or a set of physical broadcast channel (PBCH) block indexes.

61. The method of claim 58, wherein each of the pair of reference signals are configured with either one or both of at least two transmission control indicator (TCI) states.

62. The method of claim 58, wherein the pair of reference signals is for determining the set of candidate beams upon detection of the beam failure.

63. A method for wireless communication at an apparatus of a base station, comprising:
transmitting a configuration signal that instructs a user equipment (UE) to provide an index for a corresponding serving cell with a radio link quality below a threshold radio link quality; and
receiving information related to one or more candidate beams corresponding to a first serving cell based at least in part on the configuration signal, wherein a first radio link quality for the first serving cell is below the threshold radio link quality.

64. The method of claim 63, wherein:
transmitting the configuration signal further comprises transmitting the configuration signal using a type of multiplexing; and
receiving the information related to the one or more candidate beams further comprises receiving the information using the type of multiplexing.

65. The method of claim 63, wherein:
transmitting the configuration signal further comprises transmitting the configuration signal using time division multiplexing (TDM); and
receiving the information related to the one or more candidate beams further comprises receiving the information using TDM.

66. The method of claim 63, wherein:
transmitting the configuration signal further comprises transmitting the configuration signal using frequency division multiplexing (FDM); and
receiving the information related to the one or more candidate beams further comprises receiving the information using FDM.

67. A method for wireless communication at an apparatus of a base station, comprising:
receiving an indication of a set of candidate beams for connection reestablishment with a user equipment (UE) in a media access control (MAC) control element (MAC-CE) or a physical random-access channel (PRACH) transmission; and
re-establishing a connection with the UE using the set of candidate beams.

68. The method of claim 67, further comprising:
identifying a bit of the MAC-CE to determine whether there are one or two reference signal identifications in the MAC-CE.

69. The method of claim 67, further comprising:
identifying a field of the MAC-CE to determine that the UE detected a beam failure.

70. The method of claim 67, further comprising:
identifying a field of the MAC-CE that indicates a presence of a candidate reference signal identification.

71. The method of claim 67, wherein the indication of the set of candidate beams further indicates at least one candidate reference signal pair identification.

72. The method of claim 67, wherein the PRACH transmission is associated with a pair of at least one synchronization signal block (SSB) or channel state information (CSI) reference signal.

73. The method of claim 67, further comprising:
transmitting an indication of at least one search space set associated with at least one control resource set (CORESET) for a physical downlink control channel (PDCCH) transmission.

74. The method of claim 73, wherein the at least one search space set is based at least in part on at least one of a transmission control indicator (TCI) state or a quasi co-location assumption associated with the PRACH transmission.

75. An apparatus for wireless communication at an apparatus of a user equipment (UE), comprising:
means for receiving a configuration signal identifying a resource set that includes a pair of reference signals;
means for monitoring for a physical downlink control channel (PDCCH) transmission using at least two transmission control indicator (TCI) states;
means for detecting a beam failure according to the resource set and based at least in part on the monitoring; and
means for determining a set of candidate beams based at least in part on detecting the beam failure.

76. The apparatus of claim 75, further comprising:
means for transmitting the set of candidate beams to a base station based at least in part on determining the set of candidate beams.

77. The apparatus of claim 75, wherein the pair of reference signals comprises periodic channel state information reference signals (CSI-RS) resource configuration indexes, a set of synchronization signal block indexes, or a set of physical broadcast channel (PBCH) block indexes.

78. The apparatus of claim 75, wherein each of the pair of reference signals are configured with either one or both of the at least two TCI states.

79. The apparatus of claim 75, wherein the means for monitoring the PDCCH transmission further comprises:
means for monitoring at least one control resource set (CORESET) associated with the at least two TCI states, monitoring one search space set associated with at least two CORESETs, or monitoring two search space sets associated with two CORESETs each having an active TCI state.

80. The apparatus of claim 75, wherein the pair of reference signals is for determining the set of candidate beams upon detection of the beam failure.

81. An apparatus for wireless communication at an apparatus of a user equipment (UE), comprising:
means for receiving a configuration signal;
means for detecting that a first radio link quality for a first serving cell is below a threshold radio link quality;
means for providing an index for the first serving cell based at least in part on the configuration signal and detecting that the first radio link quality is below the threshold radio link quality; and
means for transmitting information related to one or more candidate beams based at least in part on the received configuration signal, wherein transmitting information related to the one or more candidate beams is in response to detecting that the first radio link quality for the first serving cell is below the threshold radio link quality.

82. The apparatus of claim 81, wherein:
the means for receiving the configuration signal further comprises means for receiving the configuration signal using a type of multiplexing;
the means for transmitting information related to the one or more candidate beams further comprises means for transmitting the information using the type of multiplexing.

83. The apparatus of claim 81, wherein:
the means for receiving the configuration signal further comprises means for receiving the configuration signal using time division multiplexing (TDM); and
the means for transmitting information related to the one or more candidate beams further comprises means for transmitting the information using TDM.

84. The apparatus of claim 81, wherein:
the means for receiving the configuration signal further comprises means for receiving the configuration signal using frequency division multiplexing (FDM); and
the means for transmitting information related to the one or more candidate beams further comprises means for transmitting the information using FDM.

85. An apparatus for wireless communication at an apparatus of a user equipment (UE), comprising:
means for monitoring a physical downlink control channel (PDCCH) transmission using at least two transmission control indicator (TCI) states;
means for detecting a beam failure according to a resource set and based at least in part on the monitoring;
means for determining a set of candidate beams based at least in part on detecting the beam failure; and
means for transmitting an indication of the set of candidate beams in a media access control (MAC) control element (MAC-CE) or a physical random-access channel (PRACH) transmission.

86. The apparatus of claim 85, further comprising:
means for setting a bit of the MAC-CE to indicate whether there are one or two reference signal identifications in the MAC-CE.

87. The apparatus of claim 85, further comprising:
means for setting a field of the MAC-CE to indicate that the beam failure is detected.

88. The apparatus of claim 85, further comprising:
means for setting a field of the MAC-CE to indicate a presence of a candidate reference signal identification.

89. The apparatus of claim 85, wherein the indication of the set of candidate beams further indicates at least one candidate reference signal pair identification.

90. The apparatus of claim 85, wherein the PRACH transmission is associated with a pair of at least one synchronization signal block (SSB) or channel state information (CSI) reference signal (CSI-RS).

91. The apparatus of claim 90, further comprising:
means for monitoring a first control resource set (CORESET) for the PDCCH transmission based at least in part on the at least two TCI states or a quasi co-location assumption associated with the PRACH transmission.

92. The apparatus of claim 90, further comprising:
means for monitoring at least one search space set associated with at least one control resource set (CORESET) for the PDCCH transmission based at least in part on the indication of the set of candidate beams.

93. The apparatus of claim 92, further comprising:
means for receiving a second indication of the at least one search space set.

94. The apparatus of claim 92, wherein the at least one search space set is based at least in part on at least one of the at least two TCI states or a quasi co-location assumption associated with the PRACH transmission.

95. An apparatus for wireless communication at an apparatus of a base station, comprising:
means for transmitting a configuration signal to a user equipment (UE) identifying a resource set that includes a pair of reference signals; and
means for receiving a set of candidate beams from the UE based at least in part on determining the set of candidate beams upon detection of a beam failure at the UE.

96. The apparatus of claim 95, further comprising:
means for re-establishing a connection with the UE using the set of candidate beams.

97. The apparatus of claim 95, wherein the pair of reference signals comprises periodic channel state information reference signal (CSI-RS) resource configuration indexes, a set of synchronization signal block indexes, or a set of physical broadcast channel (PBCH) block indexes.

98. The apparatus of claim 95, wherein each of the pair of reference signals are configured with either one or both of at least two transmission control indicator (TCI) states.

99. The apparatus of claim 95, wherein the pair of reference signals is for determining the set of candidate beams upon detection of the beam failure.

100. An apparatus for wireless communication at an apparatus of a base station, comprising:
means for transmitting a configuration signal that instructs a user equipment (UE) to provide an index for a corresponding serving cell with a radio link quality below a threshold radio link quality; and
means for receiving information related to one or more candidate beams corresponding to a first serving cell based at least in part on the configuration signal, wherein a first radio link quality for the first serving cell is below the threshold radio link quality.

101. The apparatus of claim 100, wherein:
the means for transmitting the configuration signal further comprises means for transmitting the configuration signal using a type of multiplexing; and
the means for receiving information related to the one or more candidate beams further comprises means for receiving information using the type of multiplexing.

102. The apparatus of claim 100, wherein:
the means for transmitting the configuration signal further comprises means for transmitting the configuration signal using time division multiplexing (TDM); and
the means for receiving information related to the one or more candidate beams further comprises means for receiving information using TDM.

103. The apparatus of claim 100, wherein:
the means for transmitting the configuration signal further comprises means for transmitting the configuration signal using frequency division multiplexing (FDM); and
the means for receiving information related to the one or more candidate beams further comprises means for receiving information using FDM.

104. An apparatus for wireless communication at an apparatus of a base station, comprising:
means for receiving an indication of a set of candidate beams for connection reestablishment with a user equipment (UE) in a media access control (MAC) control element (MAC-CE) or a physical random-access channel (PRACH) transmission; and
means for re-establishing a connection with the UE using the set of candidate beams.

105. The apparatus of claim 104, further comprising:
means for identifying a bit of the MAC-CE to determine whether there are one or two reference signal identifications in the MAC-CE.

106. The apparatus of claim 104, further comprising:
means for identifying a field of the MAC-CE to determine that the UE detected a beam failure.

107. The apparatus of claim 104, further comprising:
means for identifying a field of the MAC-CE that indicates a presence of a candidate reference signal identification.

108. The apparatus of claim 104, wherein the indication of the set of candidate beams further indicates at least one candidate reference signal pair identification.

109. The apparatus of claim 104, wherein the PRACH transmission is associated with a pair of at least one synchronization signal block (SSB) or channel state information (CSI) reference signal.

110. The apparatus of claim 104, further comprising:
means for transmitting an indication of at least one search space set associated with at least one control resource set (CORESET) for a physical downlink control channel (PDCCH) transmission.

111. The apparatus of claim 110, wherein the at least one search space set is based at least in part on at least one of a transmission control indicator (TCI) state or a quasi co-location assumption associated with the PRACH transmission.

112. A non-transitory computer-readable medium storing code for wireless communication at an apparatus of a user equipment (UE), the code comprising instructions executable by a processor to:
receive a configuration signal identifying a resource set that includes a pair of reference signals;
monitor for a physical downlink control channel (PDCCH) transmission using at least two transmission control indicator (TCI) states;
detect a beam failure according to the resource set and based at least in part on the monitoring; and
determine a set of candidate beams based at least in part on detecting the beam failure.

112. A non-transitory computer-readable medium storing code for wireless communication at an apparatus of a user equipment (UE), the code comprising instructions executable by a processor to:
receive a configuration signal;
detect that a first radio link quality for a first serving cell is below a threshold radio link quality;
provide an index for the first serving cell based at least in part on the configuration signal and detecting that the first radio link quality is below the threshold radio link quality; and
in response to detecting that the first radio link quality for the first serving cell is below the threshold radio link quality, transmit information related to one or more candidate beams based at least in part on the received configuration signal.

113. A non-transitory computer-readable medium storing code for wireless communication at an apparatus of a user equipment (UE), the code comprising instructions executable by a processor to:
monitor a physical downlink control channel (PDCCH) transmission using at least two transmission control indicator (TCI) states;
detect a beam failure according to a resource set and based at least in part on the monitoring;
determine a set of candidate beams based at least in part on detecting the beam failure; and
transmit an indication of the set of candidate beams in a media access control (MAC) control element (MAC-CE) or a physical random-access channel (PRACH) transmission.

114. A non-transitory computer-readable medium storing code for wireless communication at an apparatus of a base station, the code comprising instructions executable by a processor to:
transmit a configuration signal to a user equipment (UE) identifying a resource set that includes a pair of reference signals; and
receive a set of candidate beams from the UE based at least in part on determining the set of candidate beams upon detection of a beam failure at the UE.

115. A non-transitory computer-readable medium storing code for wireless communication at an apparatus of a base station, the code comprising instructions executable by a processor to:
transmit a configuration signal that instructs a user equipment (UE) to provide an index for a corresponding serving cell with a radio link quality below a threshold radio link quality; and
receive information related to one or more candidate beams corresponding to a first serving cell based at least in part on the configuration signal, wherein a first radio link quality for the first serving cell is below the threshold radio link quality.

116. A non-transitory computer-readable medium storing code for wireless communication at an apparatus of a base station, the code comprising instructions executable by a processor to:
receive an indication of a set of candidate beams for connection reestablishment with a user equipment (UE) in a media access control (MAC) control element (MAC-CE) or a physical random-access channel (PRACH) transmission; and
re-establish a connection with the UE using the set of candidate beams.
